(19) United States
(12) Patent Application Publication
(10) Pub. No.: US 2019/0347489 A1
(43) Pub. Date: Nov. 14, 2019

(54) EFFICIENT DISTRIBUTION OF DATA COLLECTED FROM INFORMATION COLLECTION DEVICES

(71) Applicant: FUJITSU LIMITED, Kawasaki-shi (JP)

(72) Inventors: ASAKO KITAURA, Kawasaki (JP); Satoshi Sano, Kawasaki (JP); Takushi Fujita, Chigasaki (JP); Eishi MORIMATSU, Kawasaki (JP)

(73) Assignee: FUJITSU LIMITED, Kawasaki-shi (JP)

(21) Appl. No.: 16/400,084

(22) Filed: May 1, 2019

(30) Foreign Application Priority Data
May 14, 2018 (JP) 2018-093382

(51) Int. Cl. G06K 9/00; G06F 16/9032; G06F 16/908

(52) U.S. Cl. CPC G06K 9/00791; G06F 16/908; G06F 16/90328

(57) ABSTRACT

An apparatus determines a correlation between a categorization result that is obtained by categorizing collecting information into at least two groups and a result that is obtained by filtering the collecting information by accompanying information, where the collecting information is collected from an information collecting apparatus that collects information concerning a mobile body. Based on the determined correlation, the apparatus determines new accompanying information that is to be mounted in the information collecting apparatus, from the accompanying information, and distributes the determined new accompanying information to the information collecting apparatus.

### CROSS-REFERENCE TO RELATED APPLICATION

This application is based upon and claims the benefit of priority of the prior Japanese Patent Application No. 2018-93382, filed on May 14, 2018, the entire contents of which are incorporated herein by reference.

### FIELD

The embodiment discussed herein is related to efficient distribution of data collected from information collection devices.

### BACKGROUND

In the related art, there is a probe technology in which on-board data is collected from on an on-board apparatus in a vehicle that moves, in which the collected on-board data is interpreted, and in which, from a result of the analyzing, a traveling state of the vehicle is checked, or a road condition, a traffic situation, or the like is analyzed. In this regard, there is a technology relating to filtering that, using a tag, narrows down pieces of on-board data that are collected.

In the related art, there is a technology that optimally sets a recording condition in a driver recorder.

Japanese Laid-open Patent Publication Nos. 2009-98738 and 2013-161238 are examples of the related art.

### SUMMARY

According to an aspect of the embodiments, an apparatus determines a correlation between a categorization result that is obtained by categorizing collecting information into at least two groups and a result that is obtained by filtering the collecting information by accompanying information, where the collecting information is collected from an information collecting apparatus that collects information concerning a mobile body. Based on the determined correlation, the apparatus determines new accompanying information that is to be mounted in the information collecting apparatus, from the accompanying information, and distributes the determined new accompanying information to the information collecting apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a descriptive diagram illustrating an example of a systematic configuration of a data distribution system according to an embodiment;

FIG. 2 is a block diagram illustrating an example of a hardware configuration of a data distribution apparatus (a server) according to the embodiment;

FIG. 3 is a block diagram illustrating an example of a hardware configuration of an on-board apparatus;

FIG. 4A and 4B are descriptive diagrams each illustrating an example of a detail of each of a data distribution method, the data distribution apparatus and the data distribution system according to the embodiment;

FIG. 5 is a descriptive diagram illustrating an example of a data configuration of on-board data;

FIG. 6A is a descriptive diagram illustrating an example (the first part thereof) of sorting through pieces of on-board data;

FIG. 6B is a descriptive diagram illustrating an example (the second part thereof) of sorting through the pieces of on-board data;

FIG. 7 is a descriptive diagram illustrating an example of a retention list of tag-attaching filter functions that are retained in the server;

FIG. 8A is a descriptive diagram illustrating an example (the first part thereof) of data that results from tag-attaching;

FIG. 8B is a descriptive diagram illustrating the example (the second part thereof) of the data that results from the tag-attaching;

FIG. 8C is a descriptive diagram illustrating the example (the third part thereof) of the data that results from the tag-attaching;

FIG. 9 is a flowchart illustrating an example (the first part thereof) of a procedure for processing by the server;

FIG. 10 is a descriptive diagram illustrating an example (the first part thereof) of correlation that uses an on-board data sorting result;

FIG. 11A is a descriptive diagram illustrating the example (the second part thereof) of the correlation that uses the on-board data sorting result;

FIG. 11B is a descriptive diagram illustrating a comparative example of a result of tag-attaching the on-board data;

FIG. 12 is a descriptive diagram illustrating the example (the third part thereof) of the correlation that uses the on-board data sorting result;

FIG. 13 is a descriptive diagram illustrating an example of calculation of an amount of data communication change due to the tag-attaching;

FIG. 14 is a flowchart illustrating the example (the second part thereof) of the procedure for the processing by the server;

FIG. 15 is a descriptive diagram illustrating an example of mounting of a tag-attaching filter function in the on-board apparatus;

FIG. 16 is a descriptive diagram illustrating an example of an additional operation of the tag-attaching filter function;

FIG. 17 is a flowchart illustrating the example (the third part thereof) of the procedure for the processing by the server; and

FIG. 18 is a flowchart illustrating an example of a procedure for processing by the on-board apparatus.

### DESCRIPTION OF EMBODIMENTS

In most cases, when the on-board apparatus performs filtering using only a tag attached, pieces of on-board data that are targets for collecting are difficult to narrow down using only tag information. In this manner, because pieces of on-board data that are targets for collecting are difficult to narrow down using these pieces of tag information, a server collects even on-board data that are originally undesirable. Accordingly, communication that serves no purpose occurs between the on-board apparatus and the server, and there is a problem in that communication cost increases to that extent.

A data distribution method, a data distribution apparatus, and a data distribution system according to an embodiment will be described in detail with reference to the drawings.

### Embodiment

Example of a Constitution of a System

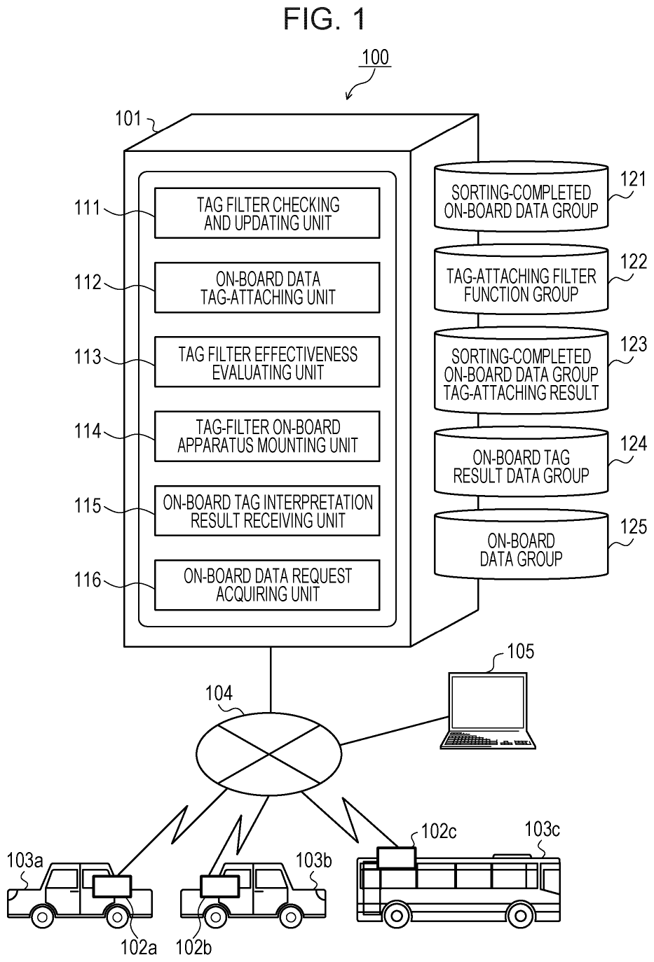

FIG. 1 is a descriptive diagram illustrating an example of a systematic configuration of a data distribution system according to the present embodiment.

In FIG. 1, the data distribution system 100 according to the embodiment includes a server 101 that is an example of the data distribution apparatus, and on-board apparatuses 102a to 102c that are examples of an information collecting apparatus, which are mounted in mobile bodies 103a to 103c, respectively. The server 101 and multiple on-board apparatuses 102a to 102c are coupled through the network 104 and constitute the data distribution system 100. Although not illustrated, the data distribution system 100 may realize its function using a cloud computing system. Hereinafter, the on-board apparatuses 102a to 102c are also collectively referred to as the on-board apparatus 102. Likewise, the mobile bodies 103a to 103c are also collectively referred to as the mobile body 103.

A terminal apparatus 105 that is operated by an operator may be connected to the network 104. The terminal apparatus 105 can be used when the operator sorts through pieces of on-board data. The terminal apparatus 105 will be described in detail below.

The server 101 has functional constituent units, a tag filter checking and updating unit 111, an on-board data tag-attaching unit 112, a tag filter effectiveness evaluating unit 113, a tag-filter on-board apparatus mounting unit 114, an on-board tag interpretation result receiving unit 115, and an on-board data request acquiring unit 116. Each of the constituent units 111 to 116 constitutes a control unit of the server 101. The constituent units 111 to 116 will be described below.

The server 101 includes various databases, a sorting-completed on-board data group 121, a tag-attaching filter function group 122, a sorting-completed on-board data group tag-attaching result 123, an on-board tag result data group 124, and an on-board data group 125. Alternatively, the server 101 is accessibly connected to these various databases 121 to 125.

For example, among the various databases 121 to 125, at least one may be provided within the server 101. Furthermore, among the various databases 121 to 125, at least one may be provided within another server of which an illustration is omitted and may be connected through a network such as the network 104. The databases 121 to 125 will be described below.

Generally, the mobile bodies 103 (103a to 103c, and so forth are automobiles (passenger vehicles or commercial vehicles such as taxis), and are not limited to these. The mobile bodies 103 include a two-wheeled vehicle (a motorcycle or a bicycle). The mobile bodies 103 may include a ship that moves on water, an airplane that moves through the air, an unmanned aircraft (a drone), an autonomous robot, and the like.

The on-board apparatus 102 (102a to 102c and so on forth) collects information of mobile body 103. The information of the mobile body 103 includes so-called on-board data that is collected from the mobile body 103. The on-board data will be described in detail below.

Included in the mobile body 103 is the on-board apparatus 102. The on-board apparatus 102 may be a dedicated apparatus that is mounted in the mobile body 103 and may be a piece of equipment that is removable. A portable terminal device, such as a smartphone or a tablet computer that includes a communication function may be used in the mobile body 103. A function of the on-board apparatus 102 may be realized using a function that the mobile body 103 includes.

Therefore, the expression “on-board” in the on-board apparatus 102 is not limitedly construed to mean the dedicated apparatus that is mounted in the mobile body. The on-board apparatus 102 may be any type of device that has a function of collecting information in the mobile body 103 and being able to transmit the collected information to the server 101.

The on-board apparatus 102a acquires on-board data of the mobile body 103a and retains the acquired on-board data. By wireless communication, various pieces of data that includes the retained on-board data are transmitted to the server 101 via the network 104. Various pieces of data that include a program which is delivered from the server 101 are received by the wireless communication via the network 104. In the same manner as the on-board apparatus 102a, the on-board apparatus 102b that is mounted in the mobile body 103b and the on-board apparatus 102c that is mounted in the mobile body 103c also perform communication with the server 101 via the network 104.

By a short-distance communication function, the on-board apparatus 102 may acquire information of a mobile body 103 that is traveling within a close proximity and may transmit the acquired information to the server 101. The on-board apparatus 102 may perform communication by the short-distance communication function and may perform communication with the server 101 via any other on-board apparatus 102.

In this way, in the data distribution system 100, the server 101 can not only acquire the on-board data from each of the on-board apparatuses 102a to 102c that are mounted in the mobile bodies 103a to 103c, respectively, but can also deliver various pieces of data that includes a filtering program, to each of the on-board apparatuses 102a to 102c.

Incidentally, in the collecting of the on-board data, for example, there is a method in which an image (a picture) that is captured with an on-board camera, which is an example of the on-board data, is checked in a data processing center (for example, the server 101) and in which it is determined whether or not dangerous driving is performed. In so doing, without transmitting all pieces of image data to the center, image data that is consistent with a certain condition, for example, only image data that results when acceleration that is at or above a prescribed value is detected is transmitted. In the collecting of the on-board data, in this manner, tag information indicating as to whether or not the on-board data is an acquisition target is kept added by a filter function of the on-board apparatus 102, and then so-called filtering is performed in which tag information is viewed at the center, pieces of on-board data that are targets for collecting are narrowed down, and thus only desirable on-board data is collected.

For example, in a general driver recorder device or the like, a fear scene is kept tag-attached, and then only a fear picture is collected and is browsed. For example, the tag information relating to the fear scene indicates whether or not a risk event that is consistent with an acceleration threshold which is set in advance occurs. Data that is collected for a specified time before and after the risk event are tag-attached, and then only a tag portion attached to the data is set to be utilized as risk data.

In some cases, depending on equipment, the on-board data (the picture) that is a risk data portion, immediately after detected, is transmitted to the server 101. However, if it is considered that the appropriateness of urgent collecting is low depending on tag contents that result from narrowing-down, in some cases, only a situation where an event occurs is kept monitored for reception on the server 101 side and the detailed on-board data (a picture or detailed controller area network (CAN) information) associated with the event is acquired by request at any time as appropriate. In either case, in performing the filtering, it is important whether or not the tag information indicating whether or not the on-board data is the acquisition target is proper.

In this manner, when collecting and using the on-board data, all pieces of on-board data (an image that is captured with the on-board camera) are not transmitted to the center (the server 101). For example, the filtering is performed in which only an image that is captured when the acceleration at or above the prescribed value is detected is transmitted. The operator checks the transmitted image in the center (the server 101) and checks whether or not a target scene is present, for example, dangerous driving is performed. Then, the on-board data is used.

However, when the filtering is performed only with a tag (for example, a tag indicating whether or not data consistent with the acceleration threshold as described above) that is attached by the on-board apparatus 102, on-board data (an image) that does not relate to dangerous driving, such as on-board data relating to reaction to a road surface, is also included. Therefore, in most cases, a situation occurs actually where pieces of on-board data that are targets for collecting are not narrowed down only with the tag information. In this manner, because only with these pieces of tag information, the pieces of on-board data that are targets for collecting are not narrowed down, even on-board data that is originally undesirable is collected. Accordingly, communication that serves no purpose is performed between the on-board apparatus 102 and the server 101 performs picture collecting, and communication cost increases to that extent.

Thus, by optimizing the tag information at any time in the on-board apparatus, on-board data collection can be realized in which only useful on-board data can be obtained at low communication cost. For example, an image that the operator is not likely to select, or a tag that accompanies any image that the operator is likely to select is estimated, tag information that has to be added on the on-board apparatus is updated according to the estimated tag, and the filter function on the on-board apparatus is updated to add the updated tag information. Thus, it is possible that the tag information which is to be added in the on-board apparatus is optimized and transmission of undesirable data is decreased.

In some cases, various pieces of on-board data other than a picture (an image), which are obtained in the on-board apparatus, for example, various pieces of on-board data, such as detailed CAN information, that can be obtained in the on-board sensor, are also used in the same manner, and thus the on-board data can be set to include these.

Thereafter, the collecting of the on-board data is described with a focus on, for example, the collecting of on-board data relating to dangerous driving, but may be performed in a case where the on-board data is collected for other purposes. For example, according to a change in a position of the mobile body or to a speed of the mobile body, on-board data (an image or the like) relating to a path for the mobile body, which has no congestion, may be collected to create a map for the vicinity of the path for the mobile body. It is desirable that for the creation of the map, an image is collected in which a neighboring feature or object, such as a road surface or a traffic sign on a path along which the mobile body travels is viewed without being hidden from sight due to another mobile body. Because of this, the filter function of the on-board apparatus that performs attaching of a tag indicating whether or not congestion occurs, such as a filter function that can collect only on-board data relating to a scene in which congestion occurs, is desired for decreasing an amount of undesired data transmission.

As another example, the collecting of the on-board data may be applied to collecting on-board data relating to a scene that is important for development for autonomous driving. For example, it is assumed that scenes, in which the image analysis of an on-board image is difficult due to backlight, are collected as a complex traffic scene in which the autonomous driving is difficult. In order to develop an algorithm that performs the autonomous driving by switching to an analysis using data that is other than an image and obtained by the on-board sensor, only on-board data relating to a useful backlight scene is collected by a filter function of attaching a tag to each backlight scene.

Alternatively, a case is considered where collecting, in which more undesired data is omitted, is performed using a filter function. In such a filter function, a tag is attached to a complex traffic scene, such as a scene of a right-turn intersection where a pedestrian or an oncoming vehicle is present in the neighborhood, an autonomous driving algorithm for which it is difficult to develop, using a steering angle or a turn indicating signal for estimating a situation where a right turn is made, a value for estimating the presence of a neighboring object or a change in a distance to the neighboring object, which is obtained by a sensor that measures a distance to the neighboring object, or the like.

These examples are examples in which the on-board data is collected for an intended application other than a precaution against dangerous driving, which is a primary object of the data collecting by the on-board apparatus in the related art, but, in the same manner as the collecting of the on-board data relating to dangerous driving, the collecting of the on-board data in the examples can be performed in the data distribution method, the data distribution apparatus, and the data distribution system according to the embodiment.

Hardware Configuration of the Data Distribution Apparatus

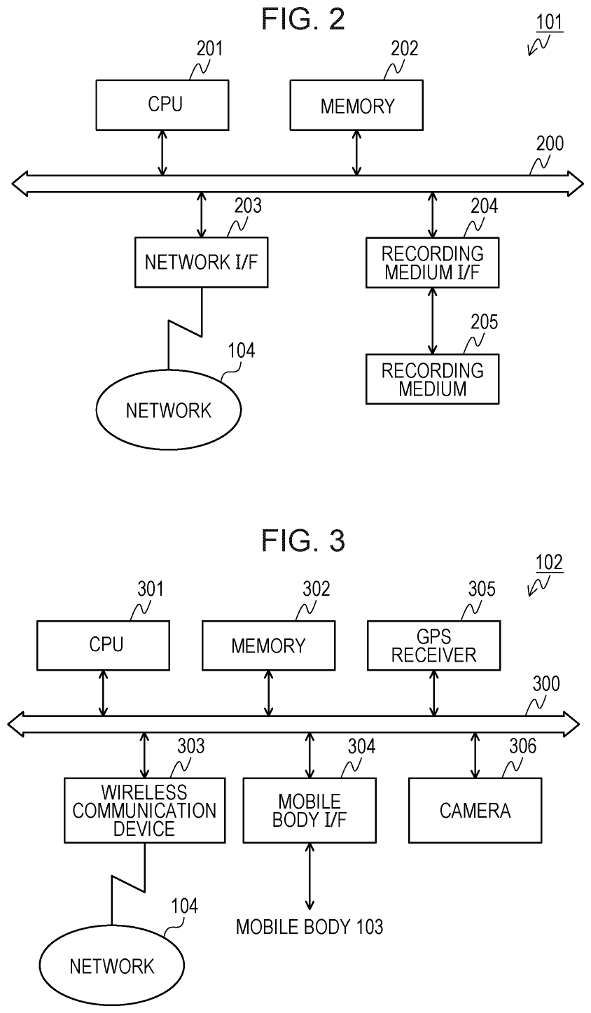

FIG. 2 is a block diagram illustrating an example of a hardware configuration of the data distribution apparatus according to the embodiment. The server 101 that is an example of the data distribution apparatus has a central processing unit (CPU) 201, a memory 202, a network interface (I/F) 203, and a recording medium I/F 204, and a recording medium 205. The constituent units are connected to each other through a bus 200. The hardware configuration is described with reference to FIG. 1.

The CPU 201 manages control of the entire server (the data distribution apparatus) 101. The memory 202, for example, has a read only memory (ROM), a random access memory (RAM), a flash ROM, and the like. For example, various programs are stored in the flash ROM or the ROM, and the RAM is used as a working area of the CPU 201. The program that is stored in the memory 202 is loaded on to the CPU 201, and thus causes the CPU 201 to perform a process that results from coding.

The network I/F 203 is connected to the network 104 via a communication line and is connected to any other apparatus (for example, the on-board apparatus 102 (102a, 102b, 102c, and so forth), any one of the databases 121 to 125, any other server, or any other system) via the network 104. The network I/F 203 manages an interface between the network 104 and the server 101, and controls input and output of data into and from any other apparatus. For example, a modem, a LAN adaptor, or the like can be employed as the network I/F 203.

The recording medium I/F 204 controls reading and writing of data from and to the recording medium 205 under the control of the CPU 201. Data that is written under the control of the recording medium I/F 204 is stored on the recording medium 205. Examples of the recording medium 205 include a magnetic disk, an optical disk and the like.

In addition to the constituent units described above, the server 101 may have, for example, a solid state driver (SSD), a keyboard, a pointing device, a display, and the like.

Example of Hardware Configuration of the On-Board Apparatus

FIG. 3 is a block diagram illustrating an example of a hardware configuration of the on-board apparatus. The hardware configuration is described with reference to FIG. 1. The on-board apparatus 102 (102a, 102b, 102c, and so forth) that is an example of the information collecting apparatus has a CPU 301, a memory 302, a wireless communication device 303, a mobile body I/F 304, and a global positioning system (GPS) receiver 305, and a camera 306. The constituent units are connected to each other through a bus 300.

The CPU 301 manages control of the entire on-board apparatus 102. The memory 302, for example, has a ROM, a RAM, and a flash ROM. For example, various programs are stored in the flash ROM or the ROM, and the RAM is used as a working area of the CPU 301. The program that is stored in the memory 302 is loaded on to the CPU 301, and thus causes the CPU 301 to perform a process that is results from coding.

The wireless communication device 303 receives a radio wave that is transmitted or transmits the radio wave. The wireless communication device 303 is configured to include an antenna and a receiver and has a function of performing transmit and reception through mobile communication (for example, 3G, 4G, 5G, PHS communication, or the like) in compliance with various communication standards, or through communication in compliance with Wi-Fi or the like.

The mobile body I/F 304 manages an interface between the mobile body 103 and the on-board apparatus 102 itself and controls input and output of data into and from the mobile body 103. Thus, the on-board apparatus 102 collects information from an ECU or various sensors that are included in the mobile body 103, via the mobile body I/F 304. The mobile body I/F 304, specifically, for example, may be a connector that is used when making a wired connection, a short-distance wireless communication (for example, Bluetooth (a registered trademark)) device, or the like.

The GPS receiver 305 receives radio waves from multiple GPS satellites and calculates a current position on the earth from information that is included in the received radio wave.

The camera 306 is a device that captures a still image or a moving image. For example, the camera 306 is configured to include a lens and an imaging element. An image that is captured by the camera 306 is retained in the memory 302. The camera 306 may include an image recognition function, a function of reading a barcode or a QR code (a registered trademark), an optical mark reader (OMR) function, an optical character reader (OCR) function, and the like. Although not illustrated, the camera 306 may include a function of recording audio at the same time as capturing a moving image (for example, a microphone).

As illustrated in FIG. 3, the GPS receiver 305 and the camera 306 may be included in the on-board apparatus 102, may be included in the mobile body 103, or may be separately attached from the outside. In a case where the GPS receiver 305 or the camera 306 is not included in the on-board apparatus 102, those pieces of information may be acquired via the mobile body I/F 304 or the like. The on-board apparatus 102, although its illustration is omitted, may include various input devices, a display, an interface for writing on a recording medium, such as a memory card, various input terminals, and the like.

Detail of the Data Distribution System

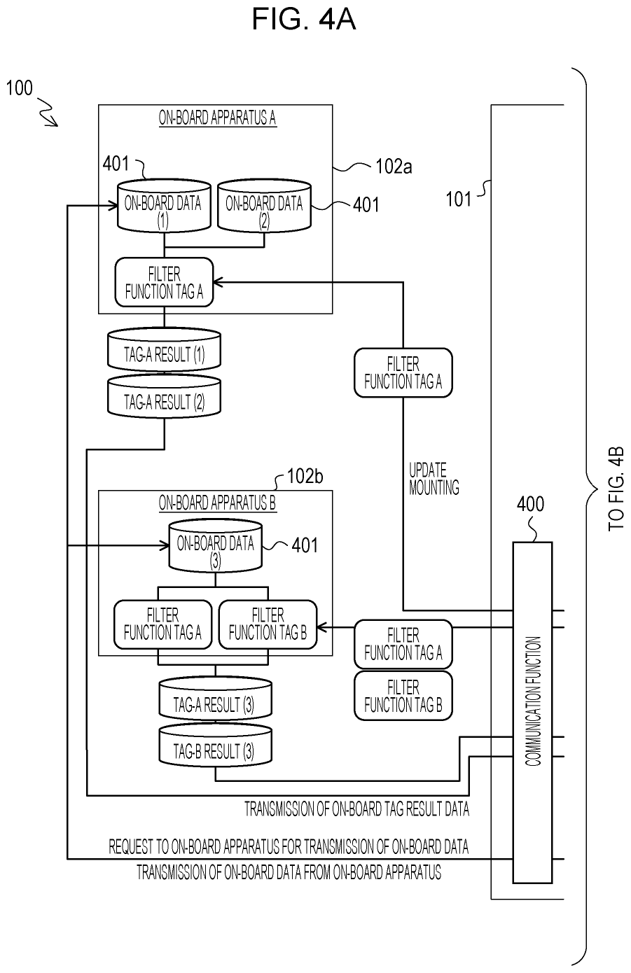

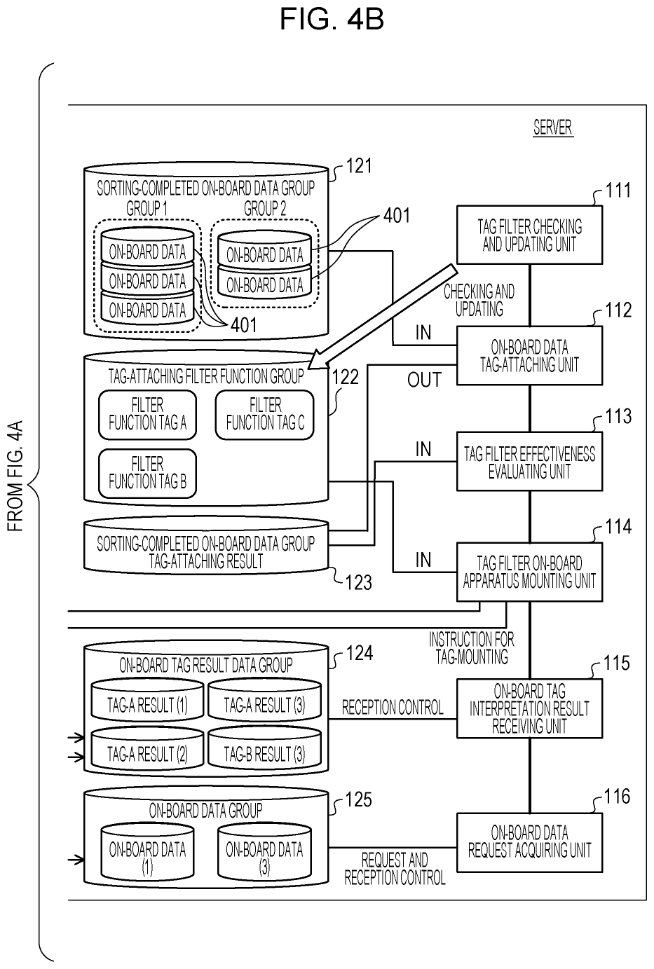

FIGS. 4A and 4B are descriptive diagrams each illustrating an example of a detail of each of the data distribution method, the data distribution apparatus and the data distribution system according to the embodiment. In FIGS. 4A and 4B, the data distribution system 100 is configured with multiple on-board apparatuses A 102a and B 102b that acquire the on-board data, and the server 101 that collects a data group that results from the tag-attaching, from these on-board apparatuses 102a and 102b and collects the on-board data by request.

In FIGS. 4A and 4B, the server (the data distribution apparatus) 101, as also illustrated in FIG. 1, includes constituent units, the tag filter checking and updating unit 111, the on-board data tag-attaching unit 112, the tag filter effectiveness evaluating unit 113, the tag-filter on-board apparatus mounting unit 114, the on-board tag interpretation result receiving unit 115, and the on-board data request acquiring unit 116. Each of the constituent units 111 to 116 constitutes a control unit of the server 101.

In FIGS. 4A and 4B, the server 101 includes various databases, the sorting-completed on-board data group 121, the tag-attaching filter function group 122, the sorting-completed on-board data group tag-attaching result 123, the on-board tag result data group 124, and the on-board data group 125.

The on-board apparatus A 102a includes a filter function of performing the tag-attaching, which is called a filter function tag A, on the on-board data that is consistent with a condition for data on a scene that is desired to be collected. The on-board apparatus B 102b includes two filter functions of performing the tag-attaching, which are called the filter function tag A and a filter function tag B, respectively.

The function of performing the tag-attaching is referred to as “(tag-attaching) filter function”, but this may include not only processing that performs the tag-attaching according to the consistency with a condition in a simple computation formula, but also processing that searches for the data using an arbitrary complex interpreting computation, for example, learning computation such as deep learning, and the like, and performs the tag-attaching.

Each on-board apparatus 102a and 102b performs the tag-attaching (filtering of data) on a data portion that is consistent with the condition by the filter function, of each piece of on-board data, such as a picture or detailed CAN information that is obtained at any time using the on-board camera, the on-board sensor or the like. For example, in the on-board apparatus A 102a, there are two on-board data files 401 (on-board data (1) and on-board data (2)). For each file, two results, a tag-A result (1) and a tag-A result (2) of performing the tag-attaching that is the filter function tag A, are obtained.

On the other hand, in the on-board apparatus B 102b, there is one on-board data file (on-board data (3)). For each file, two results, a tag-A result (3) of performing the tag-attaching that is the (filter function) tag A, and a tag-B result (3) of performing the tag-attaching that is the (filter function) tag B.

The server 101 obtains the result of performing the tag-attaching, at any time from each of the on-board apparatuses A 102a and the on-board apparatus B 102b, and so forth) by performing a communication function, and retains the obtained result in the on-board tag result data group 124. This sequence of processing operations can be performed by the on-board tag interpretation result receiving unit 115 of the server 101.

Regarding the on-board data, the on-board data request acquiring unit 116 of the server 101 makes a request to each on-board apparatus 102a and 102b to send only the desired on-board data by forming the communication function, referring to the result of performing the tag-attaching, which is retained in the on-board tag result data group 124. In FIGS. 4A and 4B, the on-board apparatus A 102a and the on-board apparatus B 102b are requested to transmit the on-board data (1) and the on-board data (3), respectively. As a result, each on-board apparatus 102a and 102b receives a transmission request from the on-board data request acquiring unit 116 of the server 101 and transmits the on-board data to the center (the server 101). The on-board data request acquiring unit 116 receives the on-board data that is transmitted from each on-board apparatus 102a and 102b, by performing a communication function 400, and retains the received on-board data in the on-board data group 125.

In this manner, because pieces of on-board data that are transmitted from the on-board apparatuses 102a and 102b to the server 101 are sorted by the filter function tag, in most cases, whether or not undesirable communication is performed depends on the suitability of the tag.

Detail of the Sorting-Completed On-Board Data Group 121

The server 101 retains the on-board data in the sorting-completed on-board data group 121. The on-board data is on-board data 401 that is acquired from each on-board apparatus 102a and 102b, may be a portion of data in the on-board data group 125 described above, and may be special on-board data that is acquired, as dedicated on-board data for optimizing the collecting itself of the on-board data itself using tag-attaching information, from each on-board apparatus 102a and 102b through separate obtainment or the like. In the latter case, although the on-board data is acquired without the on-board data request acquiring unit 116 or the communication function 400 being involved, this does not pose any problem. Because of this, although all pieces of on-board data 401, for example, are acquired in the on-board apparatuses 102a and 102b without performing sorting obtainment using the result of the tag-attaching by the on-board apparatuses 102a and 102b as is the case with the on-board data group 125 in the latter case, this does not pose any problem.

In FIGS. 4A and 4B, the sorting-completed on-board data group 121, as the on-board data group, is divided into, for example, two sorting groups, “Group 1” relating to a scene that is a target for collecting and “Group 2” relating to a scene that is not the target for collecting. In the case of the collecting of the on-board data on a danger-related scene, for example, “Group 1” relates to a fear scene.

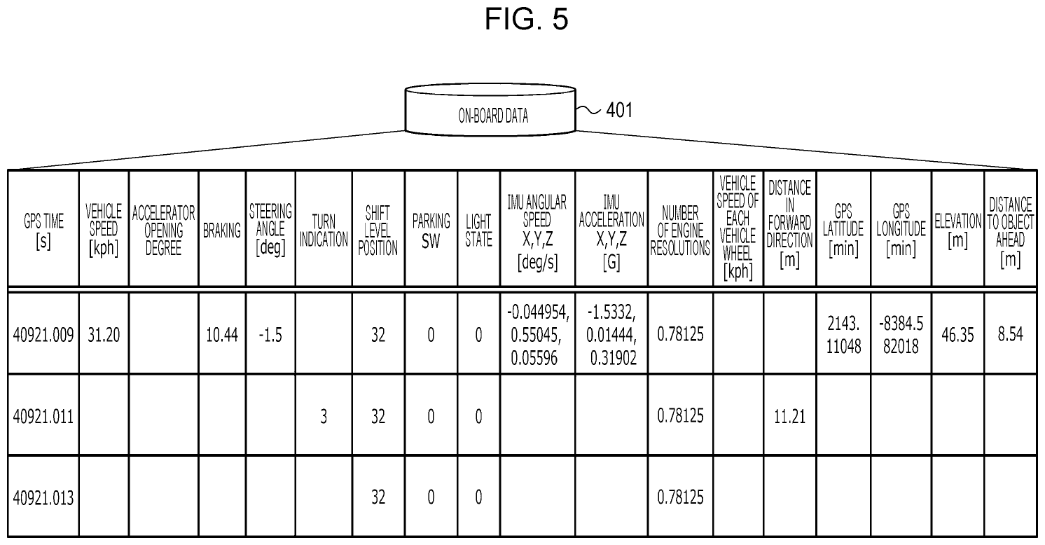

FIG. 5 is a descriptive diagram illustrating an example of a data configuration of the on-board data. In FIG. 5, the on-board data 401 is an example of on-board data other than the picture and illustrates detailed CAN data. In FIG. 5, an example of each field is illustrated. A description of a specific detail of the field is omitted here. A GPS time is recorded in a GPS time field.

In the on-board data 401, data items that are arbitrarily selected may be recorded in association with a GPS device time. Further more, all data items may be recorded, respectively, at equal intervals (for example, at equal intervals of 0.002 seconds, as illustrated in FIG. 5). The data items may be recorded at equal intervals at a timing at which any one of data item values changes. In this manner, a format of the data configuration of the on-board data 401, for example, is not limited. Therefore, the on-board data 401 may be configured appropriately depending on a detail of the respective data items.

Example of Sorting Through Pieces of On-Board Data

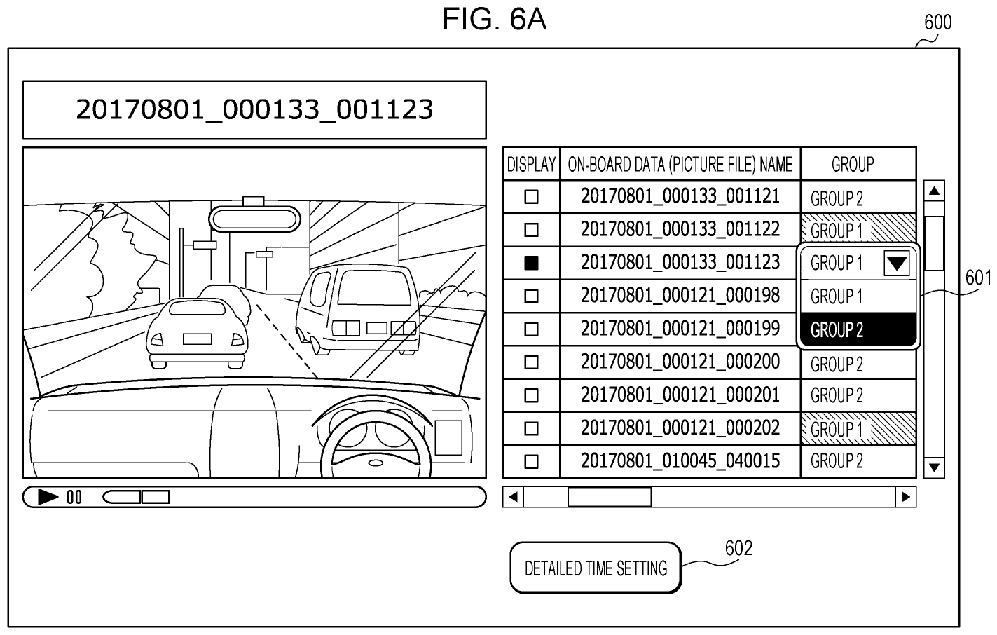

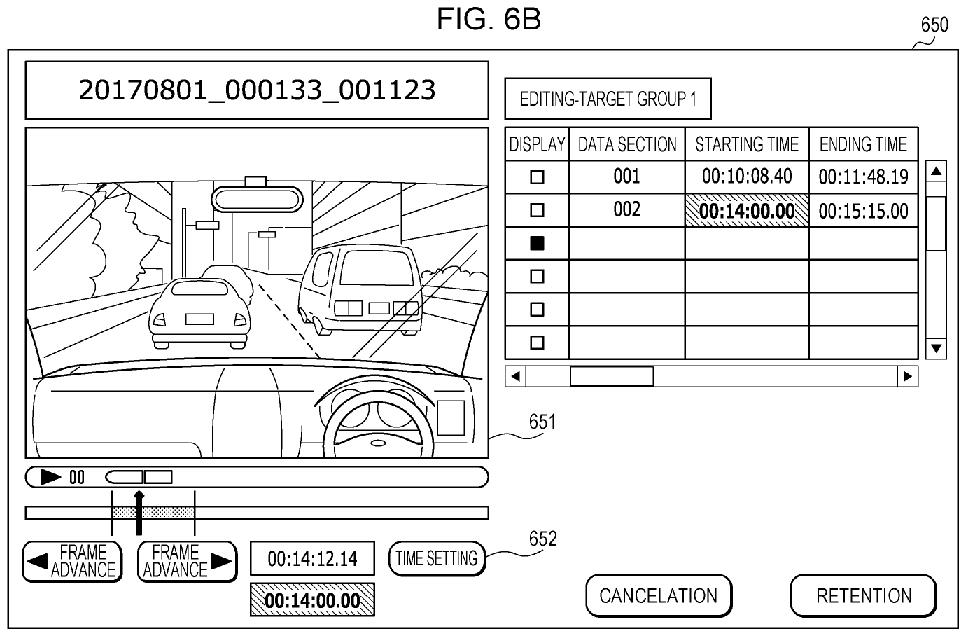

FIGS. 6A and 6B are descriptive diagrams each illustrating an example of sorting through pieces of on-board data. In FIGS. 6A and 6B, an example where the operator sorts through the pieces of on-board data and creates the sorting-completed on-board data group 121 illustrated in FIGS. 1 and 4. Data that corresponds to dangerous driving is regarded as data that is a target for collecting, and, using a user interface (UI) to the server 101, determining whether or not each of the pieces of on-board data corresponds to dangerous driving by checking an image (a picture) that is displayed (reproduced). Categorization (sorting) into data (Group 1) that corresponds to dangerous driving and data (Group 2) that does not correspond to dangerous driving takes place. Therefore, “Group 1” is a group of pieces of data that are targets for collecting, and “Group 2” is a group of pieces of data that are targets for non-collecting.

In FIG. 6A, a picture file that corresponds to every on-board data is displayed on a display screen 600 of the terminal apparatus 105 (illustrated in FIG. 1) that is operated by the operator and any of “Group 1” and “Group 2”. Because “Group 1” or “Group 2” that is selected is displayed as a list 601, the operator selects any of them and thus can easily perform the sorting.

On a detailed time setting screen 650 that is illustrated in FIG. 6B, like on a setting screen that is illustrated in FIG. 6A, not only can data be set on a per-on-board-data basis whether or not data that is a target for collecting is present (whether or not “Group 1” or “Group 2” is present), but which data section of the on-board data is consistent in detail with a target condition (whether or not a target for collecting=“Group 1”) and which data section is not consistent (whether or not a target for non-collecting=“Group 2”) can also be designated while actually checking a picture.

On the display screen 600 in FIG. 6A, when a “detailed time setting” button 602 is selected, the detailed time setting screen 650 that is illustrated in FIG. 6B is displayed. In FIG. 6B, starting and ending times at which a data section of any arbitrary group is set while checking a picture 651. Accordingly, which time section of the on-board data is consistent with the target condition (in this case, Group 1) can be set in detail.

In FIG. 6B, two data sections that are consistent with the target condition are present within the on-board data (in this case, “Group 1”), and a situation where editing of a starting time for the second data section is performed is illustrated. For example, a starting time and an ending time for the data section can be edited using a “time setting” button 652 while viewing the picture 651.

In FIG. 6B, all picture portions other than the two data section that are displayed in the form of a list are, by default, set to be in “Group 2” (non-consistence with the target condition). A default value may also be set to be freely determined according to a number of groups, sorting into which is desired to be performed, or a group number that is set to be by default.

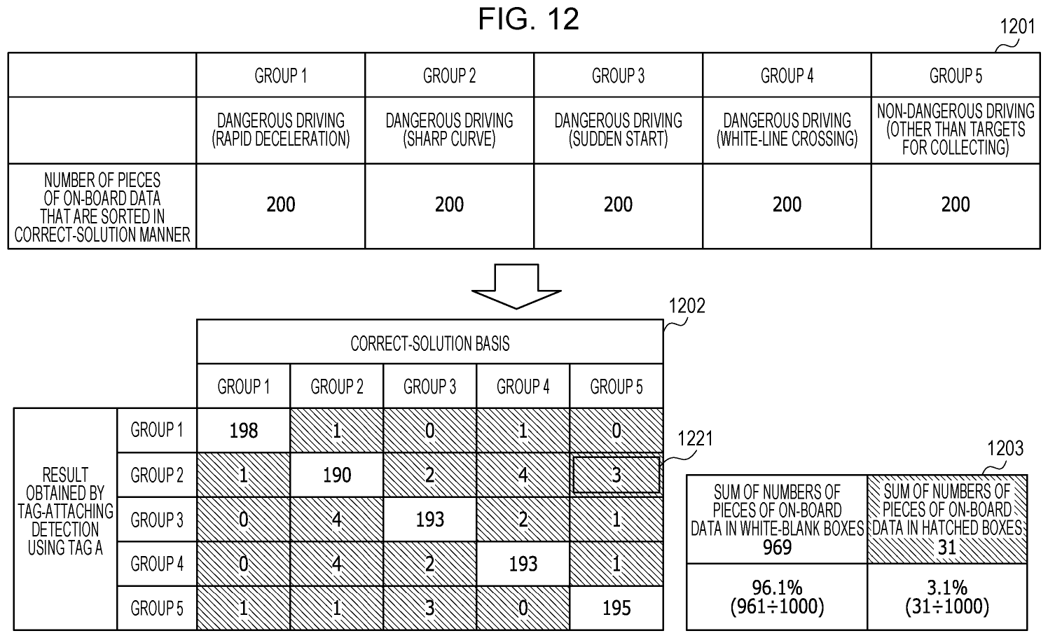

A UI that is illustrated in FIGS. 6A and 6B is an example and picture sorting and selection of a portion of a picture are not limited to a method that is illustrated in FIGS. 6A and 6B. The picture editing may be performed using an arbitrary UI. An UI may be shared through which pieces of undesirable data are sorted out from a group of pieces of on-board data that are collected from pieces of tag data. Instead of the operator performing sorting through pieces of on-board data, complex computation processing by a server that is difficult to mount in the on-board apparatus may be performed. The number of groups that results from the sorting may not be 2, and, for example, as illustrated in FIG. 12 that will be referred to, sorting into five groups relating to dangerous driving may be performed.

Regarding groups that result from the sorting, as is the case with a total of four groups, two groups relating to dangerous driving and two groups relating to map creation, the sorting may be performed for categorization of pieces on-board data, purposes of whose collecting are different.

Referring to FIGS. 2 and 4A-4B, in this manner, the categorization result may be a result that is obtained by categorizing pieces of collecting information (the on-board data 401) that are received from the information collecting apparatus (the on-board apparatus 102), into information that is selected and information that is not selected. The categorization may be set to be performed by the operator. The collecting information (the on-board data 401) may be set to include an arbitrary numerical value data that includes image data or audio data.

Detail of the Tag-Attaching Filter Function Group 122

As illustrated in FIG. 4B, the tag-attaching filter function group is a filter group that performs the tag-attaching on the on-board data, and is a collection of candidates for tag-attaching filter function that has a likelihood of being determined, in the tag filter effectiveness evaluating unit 113 that will be described below, as being mounted in the on-board apparatus. The tag-attaching filter function group is updated at an arbitrary timing.

For example, a tag-attaching filter function that uses the algorithm may be added as a new data interpretation algorithm, when developing an image processing algorithm, a signal processing algorithm, and the like. As an example, when newly developing an extraction algorithm that is strongly resistant to noise, with a pedestrian extraction algorithm, or when developing a new time and space filter in a signal process, a filter function that uses the algorithm may be set to be added. As a result of adding the filter function, for example, such a tag-attaching filter function as collects, as on-board data relating to a dangerous driving scene, on-board data in which a pedestrian is present in the neighborhood, or only on-board data that has a greater-danger characteristic than numerical data such as acceleration, can be added as a candidate for the mounting in the on-board apparatus.

In a filter function that uses a recognition algorithm through learning such as deep learning, when developing a new work flow that can perform more complex processing, a filter function that uses the work flow may be added. Although the filter function that uses the work flow is the same, because an amount of teaching data that results from teaching is increased, when it is thought that performance of a learning algorithm as a whole is improved to or above a given degree, a tag-attaching filter function may be added that uses the learning algorithm.

As a result, for example, such a tag-attaching filter function as can collect only on-board data in which a specific traffic sign is present in the neighborhood, or on-board data in which a two-wheeled vehicle is present, as on-board data on dangerous driving scene, in the neighborhood, as on-board data on a scene for autonomous driving development or for map creation, can be added as the candidate for the mounting in the on-board apparatus.

When on-board data that is a target for collecting its information changes, the tag-attaching filter function may be set to be updated. For example, in a case where, instead of on-board data on a driving scene in which usual acceleration changes greatly, a dangerous driving scene in which a warning signal newly sounds toward a following vehicle is collected among from dangerous driving scenes, it is appropriate to add a filter function that interprets audio data of the on-board data.

In a case where the on-board data is not collected even for a separate intended application, such as the map creation or the autonomous driving development, which does not relate to dangerous driving, because a different tag-attaching filter function that can perform the tag-attaching on a new driving scene is desirable, it is appropriate to add a filter function in accordance with those purposes.

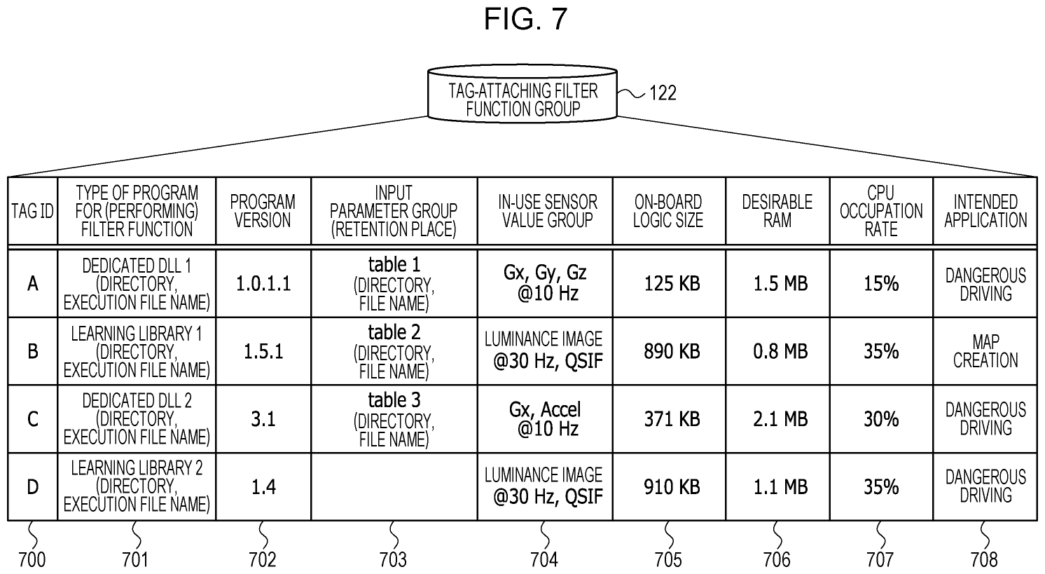

FIG. 7 is a descriptive diagram illustrating an example of a retention list of tag-attaching filter functions that are retained in the server. FIG. 7 illustrates an example of how the tag-attaching filter function group 122 with which the mounting in the on-board apparatus is determined in the server 101 (illustrated in FIG. 1) is retained in the server 101.

In FIG. 7, with reference to FIG. 1, as information relating to each tag-attaching filter function, for example, “a program type for (performing) filter function” 701 and an actual program are retained. For example, a dedicated dynamic link library (DLL) (a directory that is a place for retaining an actual DLL, or an execution file name), an execution file, a library, or the like is retained.

At this time, regarding a program or the like that does not have a likelihood of being deleted for update after being installed on the on-board apparatus 102 in order to be in common use among many tag-attaching filters, an actual program may not be retained. As an example of retaining an actual program, a location directory and a file name may be retained in FIG. 7. For easy comparison of details of programs that are performed in the tag-filter on-board apparatus mounting unit 114, a “program version” 702 may also be retained as well.

As the information relating to each tag-attaching filter function, for example, an “input parameter group” 703, a field that is used in a program is retained. In FIG. 7, pieces of information, such as a type of file (“table 1” or the like), a location directory, a file name, and the like are included as those that file-retain an input parameter. A tag-attaching filter for which the input parameter is undesirable may omit the input parameter, for example, as in a “D” record in a tag ID field.

In this manner, by separating a program and a parameter for retention management, it is possible that, although computation programs are the same, different tags are attached using different input parameters. For example, by assigning a band of frequencies at which determination is performed, or a threshold of the frequency, a filter function that performs the tag-attaching, which varies depending on a great slow change, a little-by-little small change, and the like, on a common program that frequency-interprets a sensor numerical value can be set. A filter function that performs the tag-attaching which varies depending on a size of a rectangle or the number of the rectangle, a representative luminance value of the rectangle, and the like, on a program that detects a rectangle by image interpretation can be set.

Alternatively, in a filter program for object recognition by a learning engine, by variously assigning a parameter when pre-processing the on-board data that is processed in the learning engine, although the learning engine itself is in common use, a detail of the pre-processing is changed and thus a different filter function can be set. For example, in a case where an image that is processed in the pre-processing which performs, in advance, binarization or nose removal, and normalization and the like on the on-board image, a threshold of the pre-processing or the like is changed and thus a separate filter function that outputs a different recognition result can be set.

The “type of program for (performing) filter function” 701, the “program version” 702, and the “input parameter group” 703 can be referred to when being actually mounted in the on-board apparatus in the tag-filter on-board apparatus mounting unit 114, for example, when an update difference from the existing filter function is obtained.

As the information relating to each filter-attaching function, for example, an “in-use sensor value group” 704 or specifications of the on-board apparatus in use (an “on-board logic size” 705, a RAM size (a “desirable RAM” 706) desirable at the time of processing, a “CPU occupation rate” 707 that is estimated, and the like) may be set to be retained. These specifications of the on-board apparatus and the like can be used as reference information when a tag-attaching filter function that is to be mounted in a vehicle is determined in the tag filter effectiveness evaluating unit 113.

In a case where tag-attaching filter functions for an intended application in collecting different pieces of data are present in a mixed manner, an “intended application” 708 may be set to be retained as reference information. For example, an intended application in collecting the on-board data relating to dangerous driving, an intended application in collecting the on-board data for the map creation, an intended application in collecting the on-board data for the autonomous driving development, and the like are retained and thus can be used as reference information when determining the tag-attaching filter function that is to be mounted in the vehicle.

In this manner, in the tag-attaching filter function group 122, each “tag ID” 700 record contains information relating to the tag-attaching filter function in fields, the “type of program for performing filter function” 701, the “program version” 702, the “input parameter group” 703, the “in-use sensor value group” 704, the “on-board logic size” 705, the “desirable RAM” 706, the “ CPU occupation rate” 707, the “intended application” 708, and the like.

Detail of the Sorting-Completed On-Board Data Group Tag-Attaching Result 123

The sorting-completed on-board data group tag-attaching result 123 is data that results from filtering the sorting-completed on-board data group 121 that results from the sorting by the UI as illustrated in FIGS. 6A and 6B, the complex server computation processing, or the like, regardless of the result of the sorting, using each arbitrary filter function that is included in the tag-attaching filter function group 122, and results from performing the tag-attaching on the on-board data group that results from the filtering.

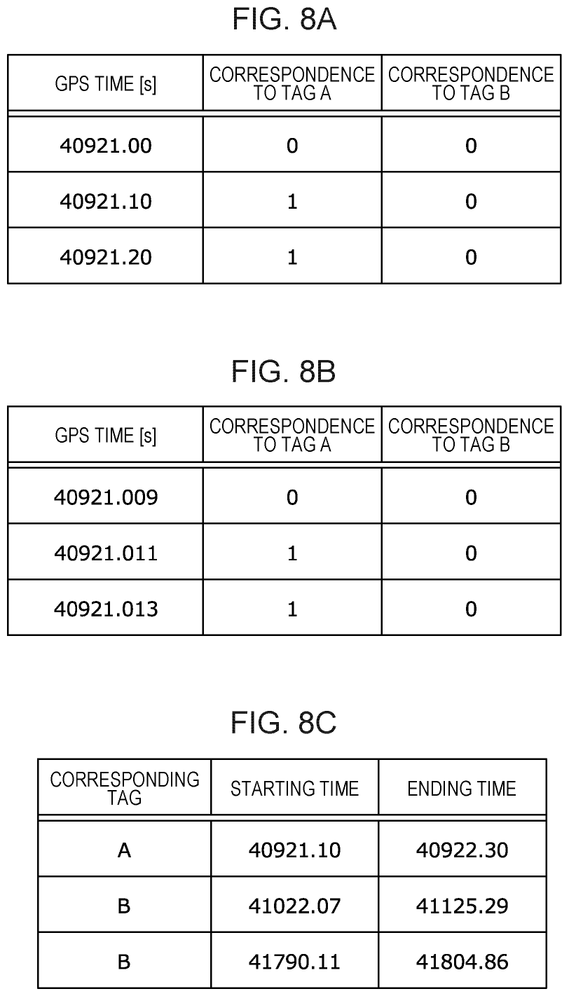

FIGS. 8A, 8B, and 8C are descriptive diagrams each illustrating an example of the data that results from the tag-attaching. FIGS. 8A to 8C each illustrate an example of the data that results from tag-attaching a tag to on-board data by performing an arbitrary filter function. In FIGS. 8A and 8B, whether the tag-attaching result is consistent with data conditions for a tag A and a tag B (1) or not (0) is illustrated in time series. As an example of a time of the on-board data, a GPS time is used that is regarded as an absolute time which is common to apparatuses.

In FIG. 8A, the tag-attaching result is retained regardless of a data time interval between pieces of detailed CAN data. Accordingly, by increasing the retention time interval, an amount of the data that results from the tag-attaching can be compressed. However, in FIG. 8A, because a flag value at a time of the detailed CAN data is not present at a pinpoint, a suitable flag value may be calculated by interpolation.

On the other hand, in FIG. 8B, the tag-attaching result is retained for each of the data times of the pieces of detailed CAN data. For this reason, in FIG. 8B, the flag value of the time of the detailed CAN data is present with pinpoint precision.

FIG. 8C illustrates an example in which starting and ending times of a data group that is consistent with the data condition are retained. In FIG. 8C, time section information that is consistent with a data condition for a flag is retained as starting and ending times of the section. For example, the starting GPS time “40921.10” and the ending time “40922.30” of a section that is consistent with the tag “A” are retained. Accordingly, the amount of the data that results from the tag-attaching may be compressed.

Procedure for Processing by the Server (Selection of the Tag-Attaching Filter Function that is to Be Mounted in the On-Board Apparatus)

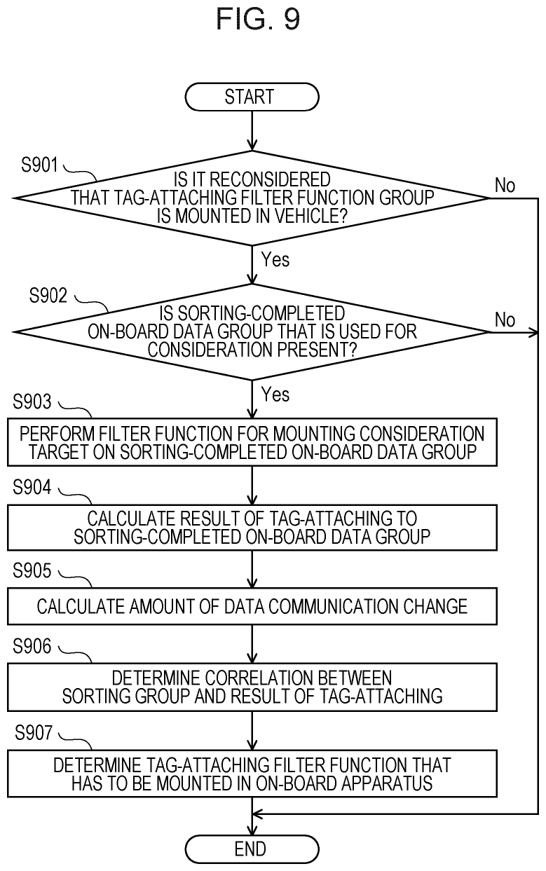

FIG. 9 is a flowchart illustrating one example of a procedure for processing by the server. In the flowchart in FIG. 9, with reference to FIG. 1, the server 101 (of the tag filter checking and updating unit 111) determines whether or not mounting of the tag-attaching filter function group 122 in the on-board apparatus 102 is reconsidered (Step S901). In a case where the mounting is not reconsidered (No in Step S901), the processing is ended without doing anything.

On the other hand, in Step S901, in a case where the mounting of the tag-attaching filter function group 122 in the on-board apparatus 102 is reconsidered (Yes in Step S901), it is determined whether or not the sorting-completed on-board data group 121 that is to be used for consideration is present (Step S902). In a case where the sorting-completed on-board data group tag-attaching result 123 is not present (No in Step S902), the processing is ended without doing anything.

On the other hand, in a case where the sorting-completed on-board data group 121 that is to be used for consideration is present (Yes in Step S902), the server 101 (of the on-board data tag-attaching unit 112) performs a filter function for a mounting consideration target on each piece of on-board data 401 in the sorting-completed on-board data group 121 (Step S903). For example, the on-board data tag-attaching unit 112 performs the filter function for the mounting consideration target (for example, filter function tags A, B, and C) on each piece of on-board data 401 in the sorting-completed on-board data group 121, and calculates a result of the tag-attaching to each piece of on-board data 401 in the sorting-completed on-board data group 121 for every tag, as the sorting-completed on-board data group tag-attaching result 123 (Step S904).

The server 101 (of the tag filter effectiveness evaluating unit 113) calculates an amount of data communication change from the sorting-completed on-board data group tag-attaching result 123 and each piece of on-board data 401 in the sorting-completed on-board data group 121, the result of the tag-attaching to which is calculated (Step S905). For example, for every on-board data 401, a change in a size of communication data is calculated from a size of the data that results from the tag-attaching and a size of on-board data. A correlation between a sorting group and the tag-attaching result that is correlated in Step S904 is determined (Step S906).

A tag-attaching filter function that has to be mounted in the on- board apparatus 102 is determined from the amount of data communication change that is calculated in Step S905 and the correlation (a relationship) that is determined in Step S906 (Step S907) and a sequence of processing operations is ended. At this time, the amount of data communication change that is calculated in Step S905 may not be considered. In such a case, the processing in Step S905 may not be performed.

As described above, in the flowchart in FIG. 9, processing operations up to and including the selection of the tag-attaching filter function that is to be mounted in the on-board apparatus 102 are illustrated. The tag filter checking and updating unit 111 performs processing of each of Steps S901 and S902, the on-board data tag-attaching unit 112 performs processing in each of Steps S903 and S904, and the tag filter effectiveness evaluating unit 113 performs processing in each of Steps S905 and S907.

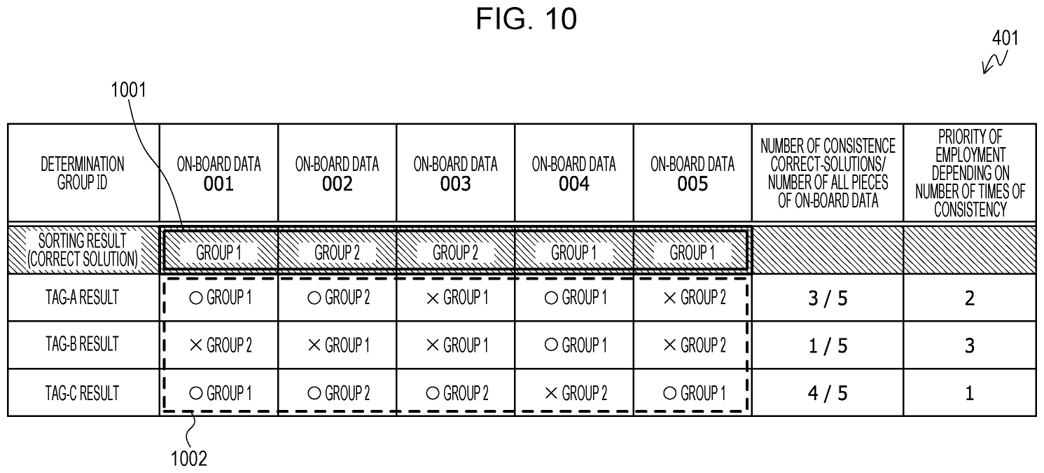

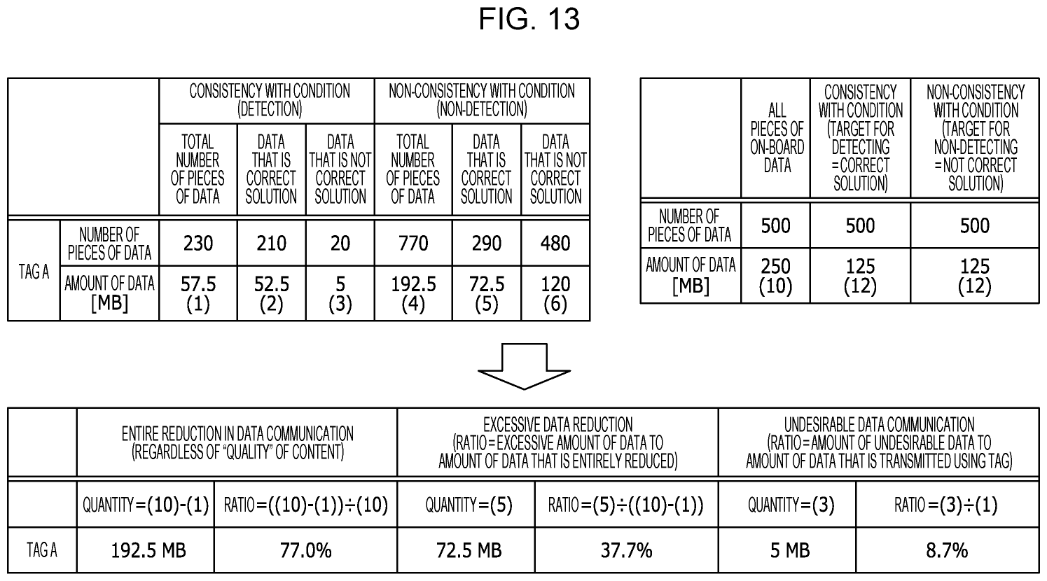

The tag filter effectiveness evaluating unit 113 computes the priority of the mounting of each tag-attaching filter function through a result of the correlation (refer to FIGS. 10 to 12 that will be described below) between the tag-attaching result and the sorting-completed on-board data group 121, and through computation (refer to FIG. 13 that will be described below) of a data reduction size or the like relating to communication data (on-board data that is collected) that results from the tag-attaching, in the perspective of the result of the correlation and the data reduction size, in order to determine the tag-attaching filter function that is to be mounted in the vehicle. Then, the tag filter effectiveness evaluating unit 113 comprehensively determines these priorities and thus determines a new tag-attaching filter function that has to be actually mounted in the vehicle.

For example, the overall priority may be calculated by adding up the priorities of the tag-attaching filter functions and may be calculated with weighting being provided for the priority of any one of the tag-attaching filter functions at the time of the adding-up. In addition to the priority, a processing specification desirable for the tag-attaching filter function is used and may be determined as being reflected in an on-board apparatus processing specification. For example, as many specifications as desirable are added in order of decreasing the priority, and at the stage at which the number of processing specifications of the on-board apparatus is exceeded, the determination of the tag-attaching filter function that is to be mounted in the vehicle may be ended.

In so doing, in a case where tag-attaching filters are present for multiple different intended applications in collecting pieces of data, the tag-attaching filter function that is to be mounted in the vehicle may be determined in such a manner that a tag-attaching filter is used for an intended application for reference information on the tag-attaching function and that tag-attaching filters are mounted for as many intended applications as possible. For example, as illustrated in FIG. 7, in a case where tag-attaching filters (A, C, and D) for an intended application in collecting pieces of data relating to dangerous driving and a tag-attaching filter B for an intended application in map update are present, for example, although all tag-attaching filters for the intended application in collecting the pieces of data relating to dangerous driving have a higher priority than the tag-attaching filter for the intended application in the map update, one tag-attaching filter for the map update is determined as being necessarily mounted. For this reason, the tag-attaching filter B is necessarily mounted.

In this manner, regarding collecting information that is acquired from the information collecting apparatus (the on-board apparatus 102) that collects information on the mobile body 103, the tag filter effectiveness evaluating unit 113 determines a correlation between a categorization result that is obtained by categorizing the collecting information into at least two groups and a result that is obtained by filtering the collecting information based on accompanying information (information (“tag-attaching filter function information”) relating to a filter function that depends on a tag indicating a data portion that is consistent with a condition), and, based on the determined correlation, can determine new accompanying information. The tag-filter on-board apparatus mounting unit 114 can distribute the determined new accompanying information to the information collecting apparatus.

The tag filter effectiveness evaluating unit 113 may determine the same mounting content (the tag-attaching filter function) for all on-board apparatuses and may determine the mounting content that varies from one on-board apparatus to another. It is desirable that the same mounting content is determined if possible. Accordingly, because the on-board data that is received is unified, post-collecting utilizing process can be facilitated and labor can be reduced. On the other hand, in a case where multiple types of on-board apparatuses are present, by determining the mounting content that is consistent with a specification of the on-board apparatus, it is possible that collecting that utilizes the specification of the on-board apparatus to a maximum.

According to a type of vehicle in which the on-board apparatus is mounted, a history of traffic of the vehicle, or the like, the mounting content may be changed. As a result, because the content of the on-board data that is collected according to the mounting content can be changed, in order to collect pieces of on-board data relating to only vehicles that have the same vehicle height or to collect the content of the on-board data that varies from one traveling area to another, it is possible that an on-board apparatus in the vehicle which has a high frequency of traveling in the area is specified, different mounting content is thus determined, and so forth.

In this manner, processing by the tag filter effectiveness evaluating unit 113, which determines new accompanying information (the tag-attaching filter function) may be set to be performed based on information relating to the information collecting apparatus (the on-board apparatus 102), the mobile body 103, information on which is collected by the information collecting apparatus, or any combination thereof.

Example of Correlation that Uses an On-Board Data Sorting Result

FIGS. 10 to 12 illustrate an example where a correlation between a group collection that results from the operator or the like performing the sorting in advance and the tag-attaching result is calculated in the tag filter effectiveness evaluating unit. FIGS. 10 to 12 illustrate an example where how much the tag-attaching result contributes to collecting of an on-board data group that is consistent with an originally desired collecting condition is determined (how much the on-board data that is desired to be collected can be collected) and thus where the order in which the tag-attaching filter functions are mounted in the on-board apparatus 102 is determined.

FIG. 10 is a descriptive diagram illustrating an example of correlation that uses the on-board data sorting result. FIG. 10 illustrates a case where a correct-solution sorting group and a group of filter tag-attaching results are compared on a per-on-board-data basis and thus the correlation is obtained. For example, FIG. 10 illustrates an example where the order in which tags are employed according to the number of times of consistency is obtained from whether a group relating to the target condition for every on-board data 401 is consistent with the correct-solution sorting group (O) or is not consistent with the correct-solution sorting group (X).

In FIG. 10, the consistency between a result of sorting targets for collecting using the tag attached to every on-board data 401 (a result for a tag A, a result for a tag B, and a result of a tag C) and a sorting group (a sorting result (a correct solution)) is checked. The total number of pieces of on-board data that have been determined as belonging to a group that is consistent with the correct solution is computed, and, based on the total number, it is determined whether or not the attached tag is a tag that is to be mounted in the on-board apparatus. For example, as illustrated in FIG. 10, the priority of the mounting is determined in the order of decreasing the total number. For example, the greater the total number of times of consistency, the higher priority is assigned.

In FIG. 10, on a per-on-board-data basis, the on-board data that is tag-attached with a filter tag-attaching result is set to be a group (Group 1) that is consistent with the target condition, and the on-board data that is not tag-attached is set to be a group (Group 2) that is not consistent with the target condition. It is checked whether or not the consistency with a correct-solution sorting result (Group 1 and Group 2) takes place, and the on-board data that belongs to the same group is regarded as the on-board data (O) from which a result that is consistent with the correct-solution sorting result has been calculated.

The correct-solution sorting group, for example, is a group relating to the dangerous driving, is desired to be collected. As to whether dangerous driving is concerned (“Group 1”=target for collecting) or not (“Group 2”), the result of the tag-attaching by tag-attaching filter function groups A to C is that the greater the number of pieces of on-board data that are consistent with the group, the higher order of the mounting in the on-board apparatus is assigned.

In FIG. 10, an example where the priority is checked using five pieces of on-board data (“on-board data 001” to “on-board data 005”) is illustrated. In a row 1001 for “sorting result (correct solution)”, results (Group 1 (a target for collecting that is dangerous driving) and Group 2 (a target for non-collecting)) of sorting pieces of on-board data are recorded. In contrast with this, in a row 1002 for “tag-A result”, “tag-B result”, and “tag-C result”, on-board data that is tag-attached with the filter tag-attaching result is set to belong to Group 1 (the target for collecting that is dangerous driving), on-board data that is not tag-attached is set to belong to Group 2 (the target for non-collecting), and on-board data that is consistent with a group in “sorting result (correct solution)” is set to be on-board data (O) from which a result with which a correct solution is consistent has been calculated.

As a result, a result of the tag C that has been correctly detected in the four pieces of on-board data is set to have the highest priority of the mounting (employing) in the on-board apparatus, and “tag-C result”->“tag-A result”->“tag-B result” are set to be employed in this order.

In FIG. 10, because the tag-attaching filter function for the tags A to C is for a filter that detects the on-board data that is the target for collecting which is dangerous driving and performs the tag-attaching, the on-board data that is tag-attached is set to belong to Group 1 (the target for collecting that is dangerous driving). However, of the tag-attaching filter function for the tags A to C is for a filter that detects the on-board data that is the target for non-collecting that is not dangerous driving and performs the tag-attaching, the on-board data that is tag-attached may be set to belong to Group 2 (the target for non-collecting).

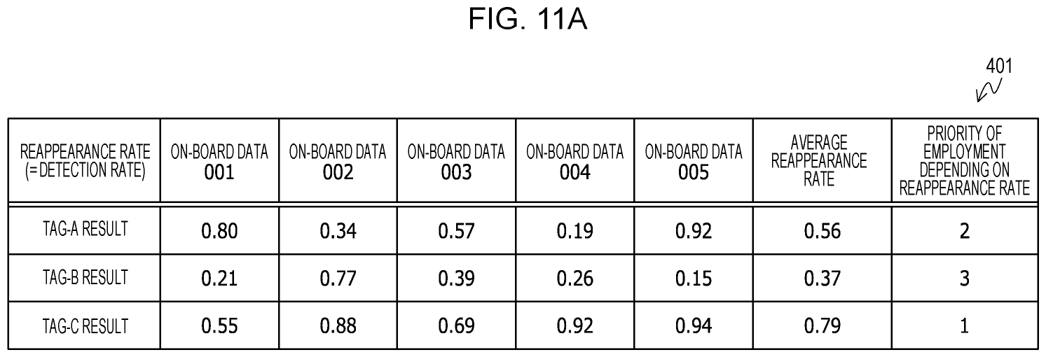

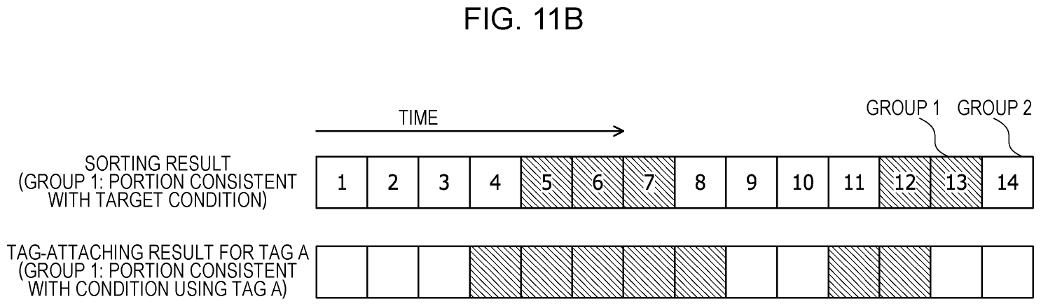

FIG. 11A is a descriptive diagram illustrating another example of the correlation that uses the on-board data sorting result. FIG. 11A is different from FIG. 10 in which the consistence with the sorting group is determined on a per-on-board-data basis. FIG. 11A illustrates an example where a situation of the consistence with the sorting group is determined for each of the time group groups that result from minutely dividing the on-board data 401.

FIG. 11B is a descriptive diagram illustrating a comparative example of the result of tag-attaching the on-board data. As illustrated in FIG. 11B, each piece of on-board data 401 is divided by a specified time interval into time block groups (1 to 14). Whether or not each of these blocks is data that is consistent with a condition for a target, such as dangerous driving, that is to be acquired (this is recorded as consistency=Group 1 and non-consistency=Group 2) is specified in advance according to the result of the sorting because the block is sorting-completed on-board data. In FIG. 11B, it is illustrated that a hatched block is “Group 1 (consistency)” and a white-colored block is “Group 2 (non-consistency).

For example, with the UI in FIG. 6B, the data section that is consistent (belongs to Group 1) with the condition for the target that is acquired for every on-board data is designated, and, by further dividing the data section by a fixed time interval into time block units, a time block that is a portion that is consistent with the target condition is prepared as illustrated in FIG. 11B. The fixed time interval of the time block is arbitrary, the time block in a time interval that is equivalent to 10 image frames of a picture may be defined, and one image frame of the picture, as is, may be defined as one time block.

Two data sections (001 and 002) within a list that indicates a data section of Group 1 in FIG. 6B are equivalent to the first data section (001)=initial three consecutive Group 1 block groups (5, 6, and 7) and the second data section (002)=subsequent two consecutive Group 1 block sections (12 and 13), respectively, in the time block group in the “sorting result (Group 1: a portion that is consistent with the target condition)” on the upper side of FIG. 11B.

In this manner, a group that is a data portion (a correct solution) that is consistent with the target condition on a per-on-board-data basis is set, in advance in a sorting manner, as the sorting-completed on-board data. A comparison with a group that is obtained from the tag-attaching result for each time block for which the tag-attaching is performed with each tag-attaching function is made. These correlation situations are computed from an arbitrary statistic value such as a reappearance rate or a false-positive ratio. The employment (the order of) for mounting (employing) in the on-board apparatus can be determined.

In FIG. 11B, in the same manner as in FIG. 10, each time block for which the tag-attaching is performed with each tag-attaching function is set to be Group 1 (a target-for-collecting portion that is consistent with the target condition).

FIG. 11A illustrates an example wherein the order of employment is determined with the reappearance rate. In FIG. 11A, regarding a time block for which the target-for-collecting (Group 1) group results from the sorting, the total number of time blocks for which the determination is correctly made is obtained by checking whether or not the correct determination as a target-for-collecting group (Group 1) is made as a result of the tag-attaching. The reappearance rate, which results from dividing by the total number of time blocks for which Group 1 that is set as the correct solution results from the sorting, is calculated for every on-board data. In FIG. 11B, because the reappearance rate of the tag-A results from dividing four time blocks (5, 6, 7, and 12) for which the correct determination is made by five total numbers (5, 6, 7, 12, and 13) of correct solutions, the reappearance rate is ⅘=0.80.

In this way, in FIG. 11A, for example, regarding the tag A, for five pieces of data from the on-board data 001 to the on-board data 005, reappearance rates “0.80”, “0.34”, “0.57”, and so forth, respectively, can be calculated. The average of these is taken and thus an average reappearance rate is set to “0.56”. For each tag, an average reappearance rate is calculated in the same manner. The higher average appearance rate for the tag, the higher order of the mounting in the on-board apparatus is assigned. This is illustrated as the order of employment that depends on the reappearance rate.

As a reappearance rate of each tag, an arbitrary statistical value, such as a minimum value, an intermediate value, or a maximum value, may be used instead of an average value of a reappearance rate of each piece of on-board data.

Instead of the reappearance rate, the false-positive ratio may be used. In a case where the false-positive ratio is used, in the same manner as the reappearance rate, the false-positive ratio of the time block is calculated on a per-on-board-data basis, averaging is performed using the on-board data group, and an average false-positive ratio is calculated. In an example in FIG. 11B, the false-positive ratio is a ratio of three blocks (4, 8, and 11) that are Group 1 blocks due to erroneous tag-attaching to nine Group 2 blocks (1, 2, 3, 4, 8, 9, 10, 11, and 14) that are not consistent with a collecting condition. Because of this, the false-positive ratio is 3/9=0.333. Because the false-positive ratio is a value that is involved in a detection error that the tag-attaching as Group 1 that is excessively consistent with the collecting condition is erroneously performed, when the order of employment in the mounting in the on-board apparatus is determined using the false-positive ratio, the lower the false-positive ratio, the higher order of employment may be set to be assigned.

In FIGS. 10 and 11A, a case where there are two groups as is the case with the question of whether an on-board data group that results from the sorting is the target for collecting (“Group 1” or not “Group 2”) is illustrated, but no limitation to this is imposed. The target for collecting may be further divided into smaller groups, a correlation may be computed among two or more groups, and the tag-attaching filter function that is a target for the mounting in the on-board apparatus may be determined.

FIG. 12 is a descriptive diagram illustrating still another example of the correlation that uses the on-board data sorting result. FIG. 12 illustrates an example in which the mounting of the tag-attaching filter function in the on-board apparatus 102 is determined using the correlation, for example, in case where there are five groups that results from the sorting.

In FIG. 12, as illustrated in Table 1201 on the upper side, five groups (“Group 1” to “Group 5”) are assumed in advance. The operator or the like sets which group each piece of on-board data corresponds to. For example, four types of dangerous driving groups (“rapid deceleration”, “sharp curve”, “sudden start”, “white-line crossing”) and other groups (other than the targets for collecting) are assumed and 200 pieces of on-board data per type are assumed to be present. At this time, for brief description, any one of the pieces of on-board data is assumed to necessarily belong to only one group.

When the on-board data belongs to multiple dangerous driving groups, a new group that results from bundling up multiple dangers may be created. By doing this, it is possible that each piece of on-board data belongs to only one group as a result of the sorting.

For simplification, FIG. 12 illustrates four sorting groups (when the target for non-collecting is included, five sorting groups) in a case where there is a purpose of collecting one piece of on-board data, that is, dangerous driving as an example, but in a case where collecting of multiple different pieces of on-board data is also performed at the same time, sorting groups relating to their intended applications may be present in a mixed manner.

As illustrated in Table 1202 on the lower portion of FIG. 12, a result of applying one tag-attaching filter function (the tag A) that is desired to determine the mounting in the on-board apparatus, on the on-board data groups that are sorted into five groups is presented in table format.

The tag-attaching filter function for the tag A performs the tag-attaching indicating to which of the five groups the on-board data relates. For simplification, it is here assumed that the tag A is divided into five types of detailed tags that correspond to the five groups, that is, a tag A1 that corresponds to Group 1 of the five groups, a tag A2 that corresponds to Group 2, and so forth. As a result, by performing five types of tag-attaching on each piece of on-board data, it is detected that there is on-board data that belongs to each of the five groups.

Instead of being divided into all the five groups of detailed tags, the tag A may be divided into only one or several groups of details tags. For example, it is assumed that only tag-attaching of the detailed tags A1 and A2 relating to Groups 1 and 2 for dangerous driving is possible for the tag A. In this case, instead of the tags A1 and A2, the tag-attaching of a tag for data corresponding neither A1 nor A2, for example, the tag-attaching of a tag in Group 5 (the tag A5) that is not a target for collecting, is performed for the remaining on-board data groups of Groups 3 and 4 for dangerous driving. As a result, by the tag-attaching, all pieces of on-board data may be detected as belonging to any one of Groups 1, 2, and 5.

In Table 1202, a component (a white-blank portion) in a diagonal line indicates the number of pieces of on-board data from which the group has been correctly detected from the tag-attaching result. A component (a hatched portion) other than the component in a diagonal line indicates the number of on-board data from which the group is detected as an incorrect group. For example, a numerical value “3” in a box 1221 indicates that, among 200 pieces of on-board data that are sorted into Group 5 in a correct-solution manner, there are three pieces of on-board data that are detected as belonging to Group 2 due to incorrect tag-attaching of the detailed tag A2 by performing tag-attaching detection by tag-attaching for the tag A (actually, five detailed tags, the detailed tags A1, A2, A3, A4, and A5).

In Table 1203, a sum of the numbers of pieces of on-board data in white-blank boxes and a sum of the numbers of pieces of on-board data in hatched boxes are illustrated. For example, in a case where the tag-attaching filter function, as when uniformly a good result is uniformly derived for all groups, is desired to be preferentially mounted, the tag-attaching filter function, as when the sum of the numbers of pieces of on-board data is maximized (the number of pieces of data: 969 (96.9%: a ratio of 969 to the total number of pieces of data)), as illustrated in Table 1202 or as illustrated in Table 1203, for each tag-attaching result, is selected as the tag-attaching filter function that is to be preferentially mounted in the vehicle. Alternatively, the tag-attaching filter function, as when the sum of the numbers of pieces of data in the hatched boxes is minimized (the number of pieces of data: 31 (3.1%: a ratio of 31 to the total number of pieces of on-board data)), may be selected as the tag-attaching filter function that is to be preferentially mounted in the vehicle.

On the other hand, in a case where the tag-attaching filter function, as when the tag-attaching filter function, as when detection results relating to one or several groups take precedence, is desired to be preferentially mounted in the vehicle, the tag-attaching filter function, as when a sum of the numbers of components in a diagonal line in “Group 1” and “Group 3” (“198”+“193”=391 in Table 1202) is maximized, may be set to be preferentially selected while the corresponding group, for example, “rapid deceleration” and “sudden start” take precedence.

In this manner, the tag filter effectiveness evaluating unit 113 (illustrated in FIG. 4B) can perform processing that determines the correlation, or processing that determines new accompanying information (the tag-attaching filter function), based on the number of times of consistence with, or the number of times of non-consistence with, each piece of collecting information (on-board data) in any one group that results from the categorization, in the categorization result, or any combination thereof.

FIG. 13 is a descriptive diagram illustrating an example of calculation of the amount of data communication change due to the tag-attaching. In FIG. 13, an example of the calculation of the amount of data communication change due to the tag-attaching filter function, in which the tag filter effectiveness evaluating unit 113 is used. In FIG. 13, for brief description, computation is performed on the assumption that all pieces of on-board data have the same size (250 MB). In a case where sizes are different, a total of amounts of sorting-completed on-board data of a target may be calculated.

In FIG. 13, three examples of calculation are illustrated. In the first calculation (total reduction in “data communication”), the extent to which the on-board data that is to be collected is actually reduced as a result of using the tag A is calculated, regardless of the quality of the on-board data that is to be collected (for example, the failure to obtain desired data, or the obtaining of surplus data), such as the degree to which incorrect on-board data due to the tag A is collected in surplus, or the degree to which desirable on-board data is missing.

For example, an amount of data communication that is reduced in the use of the tag A, for example, is defined as an amount of data that results from subtracting an amount of all data in the on-board data group (1) that is tag-attached with the tag A from an amount of all data in all on-board data groups (10) that results from the sorting by the operator. For example, an amount of reduction in data communication=“the absence of a tag-attaching function=transmission of all pieces of on-board data (10)”—“the presence of each tag-attaching function=transmission of some of the on-board data (1)”, and 250 MB−57.5 MB=192.5 MB. A data reduction rate thereof is ((10)−(1))÷(10)=77.0%.

In the second calculation (“excessive reduction in data”), the amount of data communication change is calculated as an amount of all data in the on-board data group that are not detected using the tag, among pieces of on-board data that are the targets for collecting that result from the sorting (the targets for collecting that are consistent with the condition, which are referred to as “correct solutions”). For example, in a case where changes in the amount of data, which also include the quality of collected on-board data that changes with the use of the tag A, is desired to be computed, for example, as a result of using the tag A, “an amount of on-board data that is difficult to acquire”=“data that is not detected among correct solutions” (5) is calculated. For example, correct-solution data (5) that is not consistent with the condition (is not detected) is an amount of on-board data that is difficult to acquire, and the amount of data is 72.5 MB. A rate of reduction in the excessive amount of data is (5)÷((10)−(1))=8.7%.

In the third calculation (undesirable data communication), the amount of data communication change is calculated as an amount of all data in the on-board data group that is detected using the tag A, among on-board data groups that are not the targets for collecting (correct solutions) that results from the sorting. For example, as a result of using the tag A, an amount of on-board data that has been collected in surplus is calculated as an amount of undesirable data communication. It is determined that, as pieces of data that are originally undesirable, “pieces of data that are detected among pieces of data that are not correct solutions”=an “amount of undesirable data communication” (3). The amount of data is 5 MB. A rate at which undesirable data increases (3)÷(1)=8.7%.

As described above, the tag filter effectiveness evaluating unit 113 can calculate any one of an amount of data reduction that does not consider the quality and an amount of incorrect data that considers the quality (an amount of data that is excessively reduced and thus is difficult to collect, or an amount of undesirable data that is collected in surplus), as an amount of data that changes by the use of a tag, can line up the tag-attaching filter functions in order of decreasing or increasing these amounts, and can select the tag-attaching filter function that is to be mounted in the vehicle. As a result, it is possible that an effect of reducing communication cost much more is determined considering not only the amount, but also the collecting quality and that the tag-attaching filter function that is to be mounted in the on-board apparatus is determined.

In this manner, the tag filter effectiveness evaluating unit 113 can perform processing that predicts the amount of data communication change pertaining to communication of the collecting information (the on-board data 401 illustrated in FIG. 11A) from the information collecting apparatus (the on-board apparatus 102 illustrated in FIG. 3) that entails a change in the accompanying information (the tag-attaching filter function), and can perform processing that determines new accompanying information based on the predicted amount of data communication change.

The calculation of the amount of data communication change is an option, and processing for the calculation may not be performed. In such a case, the tag filter effectiveness evaluating unit 113 does not perform the processing that determines the new accompanying information that is based on the amount of data communication change.

Mounting of the Tag-Attaching Filter Function in the On-Board Apparatus

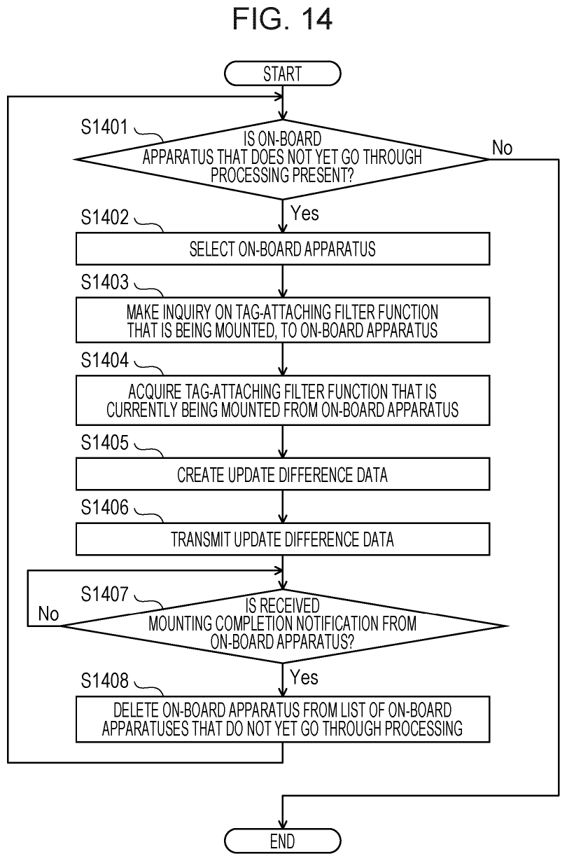

FIG. 14 is a flowchart illustrating another example of the procedure for the processing by the server with reference to FIG. 1. In the flowchart in FIG. 14, the server 101 (of the tag-filter on-board apparatus mounting unit 114) determines whether or not the on-board apparatus that does not yet go through processing is present, among the on-board apparatuses 102 in which a new tag-attaching filter function is desired to be mounted (Step S1401). In a case where the on-board apparatus that does not yet go through the processing is present (No in Step S1401), the processing is ended without doing anything.

On the other hand, in Step S1401, in a case where the on-board apparatus that does not yet go through the processing (Yes in Step S1401), one on-board apparatus in which a new function is desired to be mounted is selected (Step S1402). An inquiry on a new tag-attaching filter function that is being mounted in the on-board apparatus is made to the on-board apparatus (Step S1403). The inquiry includes a type, a version, and a parameter of tag-attaching filter function that is being mounted in the on-board apparatus. The server 101 can make the inquiry to the on-board apparatus 102 by performing the communication function 400.

The tag-attaching filter function that is currently being mounted in the on-board apparatus 102 is acquired from the on-board apparatus 102 (Step S1404). The tag-attaching filter function can also be acquired by performing the communication function 400.

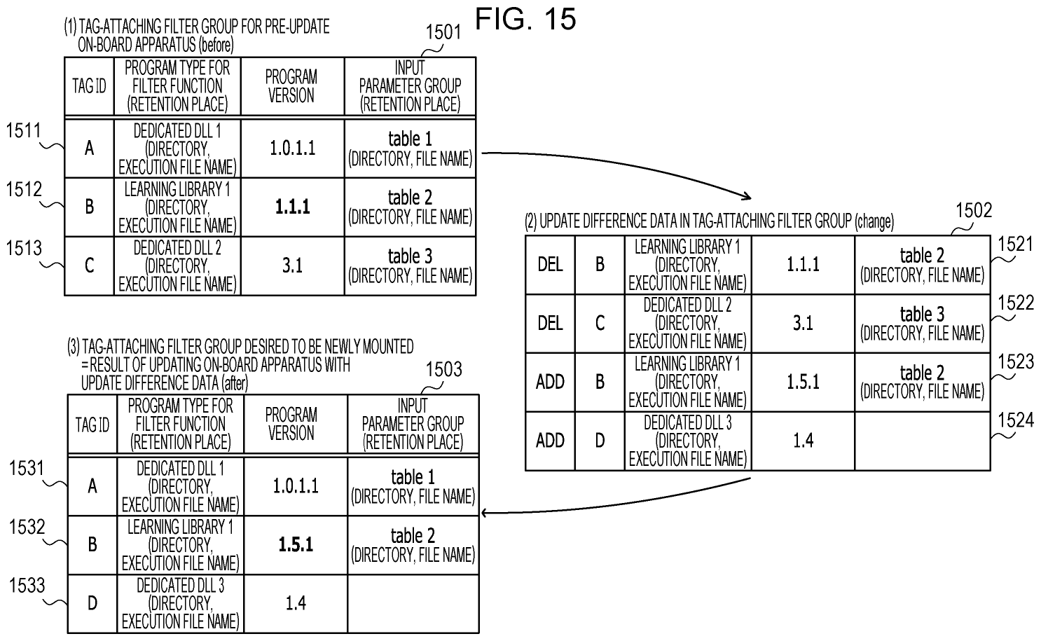

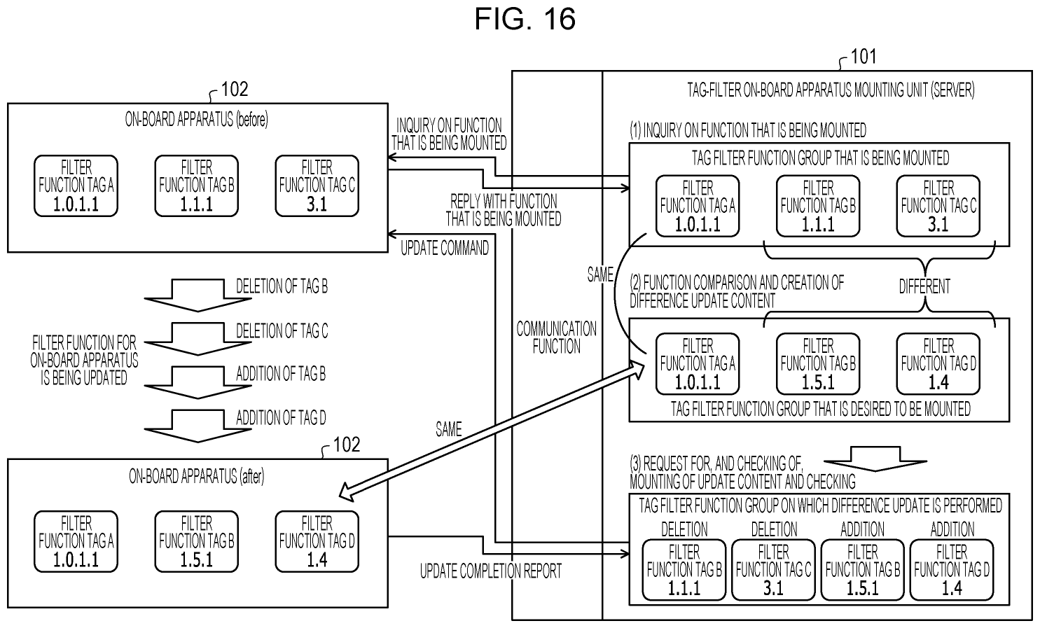

Update difference data is created based on the acquired tag-attaching filter function that is currently being mounted (Step S1405). A detail of the creation of the update difference data will be specifically described below with reference to FIGS. 15 and 16. The created update difference data is transmitted to the on-board apparatus 102 (Step S1406).

Thereafter, it is determined whether or not a mounting completion notification is received from the on-board apparatus 102 (Step S1407). The server 101 waits to receive the mounting completion notification (No in Step S1407), and, in a case where the mounting completion notification is received (Yes in Step S1407), the on-board apparatus 102 is deleted from a list of on-board apparatuses that do not yet go through the processing (Step S1408). Returning to Step S1401 takes place. Thereafter, the processing in each of Step S1401 to Step S1408 is repeated until there is no on-board apparatus that does not yet go through the processing (No in Step S1401).

In this manner, in the flowchart in FIG. 14, the processing operations up to and including the processing operation of mounting the selected new tag-attaching filter function in the on-board apparatus are illustrated. The tag-filter on-board apparatus mounting unit 114 performs a sequence of processing operations in Step S1401 to S1408. Therefore, only a difference between the accompanying information (the tag-attaching filter function information) that the information collecting apparatus (the on-board apparatus 102) has and the new accompanying information can be distributed.

FIG. 15 is a descriptive diagram illustrating an example of the mounting of the tag-attaching filter function in the on-board apparatus. FIG. 16 is a descriptive diagram illustrating an example of an additional operation of the tag-attaching filter function.

As illustrated in FIGS. 15 and 16 with reference to FIG. 1, the tag-filter on-board apparatus mounting unit 114 performs checking and distributing of the tag-attaching filter function that has to be actually mounted in the on-board apparatus 102, while suitably communicating with the on-board apparatus 102. At this time, on the server 101 side, a portion of the information (FIG. 7) on the tag-attaching filter function that is retained is communicated to the on-board apparatus 102, and the update difference data desirable for mounting replacement in the on-board apparatus 102 is determined.

For example, in FIG. 15, a case is assumed where it is determined in the tag filter effectiveness evaluating unit 113 that a tag-attaching filter function group such as a “tag-attaching filter group desired to be newly mounted” 1503 is mounted in the on-board apparatus 102. The “tag-attaching filter group desired to be newly mounted” 1503 is made up of three tag-attaching filter functions, a tag ID: “A” 1531, a tag ID: “B” 1532, and a tag ID: “C” 1533.

The tag-filter on-board apparatus mounting unit 114 makes an inquiry on the tag-attaching filter function group 122 that is currently being mounted in the on-board apparatus 102, to the on-board apparatus by performing the communication function 400, and acquires a “tag-attaching filter group for pre-update on-board apparatus” 1501. The “tag-attaching filter group for pre-update on-board apparatus” 1501 is made up of three tag-attaching filter functions, a tag ID: “A” 1511, and a tag ID: “B” 1512, a tag ID: “C” 1513.

The tag-filter on-board apparatus mounting unit 114 compares the “tag-attaching filter group for pre-update on-board apparatus” 1501 and the “tag-attaching filter group desired to be newly mounted” 1503, and creates update difference data for update (an “update difference data in tag-attaching filter group” 1502) in order to instruct the on-board apparatus 102 to update the tag-attaching filter function. The “update difference data in tag-attaching filter group” 1502 is configured with four pieces of data, pieces of data 1521, 1522, 1523, and 1524.

An example is described where, in a case where, although programs are the same, their versions are different, or data input patterns are different, an old tag-attaching filter function, the mounting of which is completed, is once deleted (DEL) from the on-board apparatus 102, where a new tag-attaching filter function is thereafter mounted (ADD) and where the update is realized.

For example, a version of the tag ID: “B” 1512 of the “tag-attaching filter group for pre-update on-board apparatus” 1501 is old and the tag ID thereof: “C” 1513 is other than a new use target, the server deletes (DEL) this as the update difference data. This is the first half of the “update difference data in a tag-attaching filter group” 1502, that is, two pieces of data, the data 1521 and the data 1522.

Instead of realizing the update with the deletion and the mounting of the program or all the parameters as in this example, the update may be set to be realized using a method in which a different portion is checked by binary comparison or the like of the program or the input parameter, in which only the different portion is sent, and in which a portion of the program or of the input parameter is replaced.

Subsequently, update difference data is created in such a manner that the tag ID: “B” 1532 of the “tag-attaching filter group desired to be newly mounted” 1503, which is a new version, and the tag ID: “D” 1533 thereof, which is a new use target, are added (ADD) to the on-board apparatus 102. This is, the second half of the “update difference data in a tag-attaching filter group” 1502, that is, two pieces of data, the data 1523 and the data 1524.

Regarding the addition (ADD), as in the deletion (DEL), not only a target is designated, but an execution file of a program with a tag-attaching filter function that is a target, and a file of an input parameter are also actually designated. At the same time, the execution file of the program and the file of the input parameter are transmitted to the on-board apparatus 102.

On the other hand, the on-board apparatus 102 deletes the tag-attaching filter function group that is mounted, using the actual execution file of the program and the actual file the input parameter that are obtained at the same time, according to the “update difference data in a tag-attaching filter group” 1502 that is obtained from the tag-filter on-board apparatus mounting unit 114 of the server 101 by performing the communication function 400, and performs any one of new additional mounting and overwriting mounting. The server 101 is notified that the processing is completed (an update completion report). The tag-filter on-board apparatus mounting unit 114 of the server 101 knows that the mounting in the on-board apparatus is completed, by receiving the update completion report.

In this manner, the tag-filter on-board apparatus mounting unit 114 can perform processing relating to the mounting of the tag-attaching filter function, on each on-board apparatus 102.

Procedure for the Processing by the Server (Reception of On-Board Tag Result Data and Request for the On-Board Data)

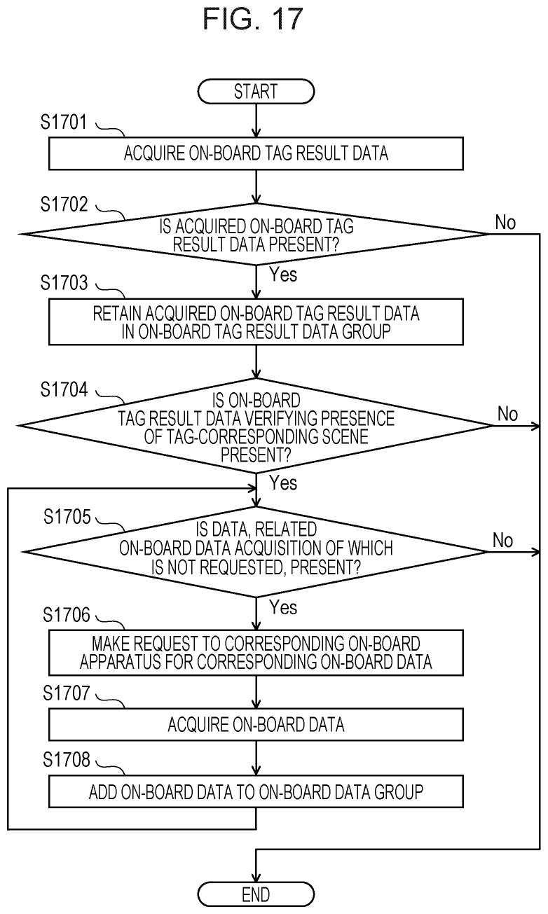

FIG. 17 is a flowchart illustrating still another example of the procedure for the processing by the server. In the flowchart in FIG. 17 with reference to FIG. 1, the server 101 (of the on-board tag interpretation result receiving unit 115) first acquires on-board tag result data from each on-board apparatus 102 (Step S1701). The acquisition of the on-board tag result data is performed by the transmission from each on-board apparatus 102 to the server 101 by performing the communication function.

The on-board tag interpretation result receiving unit 115 determines whether or not the acquired on-board tag result data is present (Step S1702). In a case where the acquired on-board tag data is not present (No in Step S1702), the processing is ended without doing anything.

On the other hand, in Step S1702, in a case where the acquired on-board tag result data is present (Yes in Step S1702), the acquired on-board tag result data is retained in the on-board tag result data group 124 (Step S1703).

The server 101 (of the on-board data request acquiring unit 116) determines whether or not on-board tag result data verifying the presence of a tag-corresponding scene, is present, among pieces of on-board tag result data that are retained in the on-board tag result data group 124 in Step S1703 (Step S1704). In a case where the on-board tag result data verifying the presence of a tag-corresponding scene is not present (No in Step S1704), the processing is ended.

On the other hand, in Step S1704, in a case where the on-board tag result data verifying the presence of a tag-corresponding scene is present (Yes in Step S1704), using the on-board tag result data in which a scene corresponding to the tag is present, it is determined whether or not data, related on-board data acquisition of which is not requested, is present (Step S1705). In a case where the data, the related on-board data acquisition of which is not requested, is present (Yes in Step S1705), a request for the corresponding on-board data is made to the on-board apparatus that corresponds to the related on-board data (Step S1706).

The corresponding on-board data is acquired from the corresponding on-board apparatus (Step S1707), and the acquired on-board data is retained (added to) in the on-board data group 125 (Step S1708). Thereafter, returning Step S1705 takes place. Subsequently, the processing in each of Step S1705 to S1708 is repeated. In Step S1705, in a case where the data, the related on-board data acquisition of which is not requested, is not present (No in Step S1705), a sequence of processing operations is ended.

In this manner, in the flowchart in FIG. 17, the reception of the on-board tag result data, the request for the on-board data, and the processing operations up to and including the addition of the requested on-board data are illustrated. The on-board tag interpretation result receiving unit 115 performs the processing in each of Steps S1701 to S1703, and the on-board data request acquiring unit 116 performs the processing in each of Steps S1704 to 1708.

Procedure for the Processing by the On-Board Apparatus

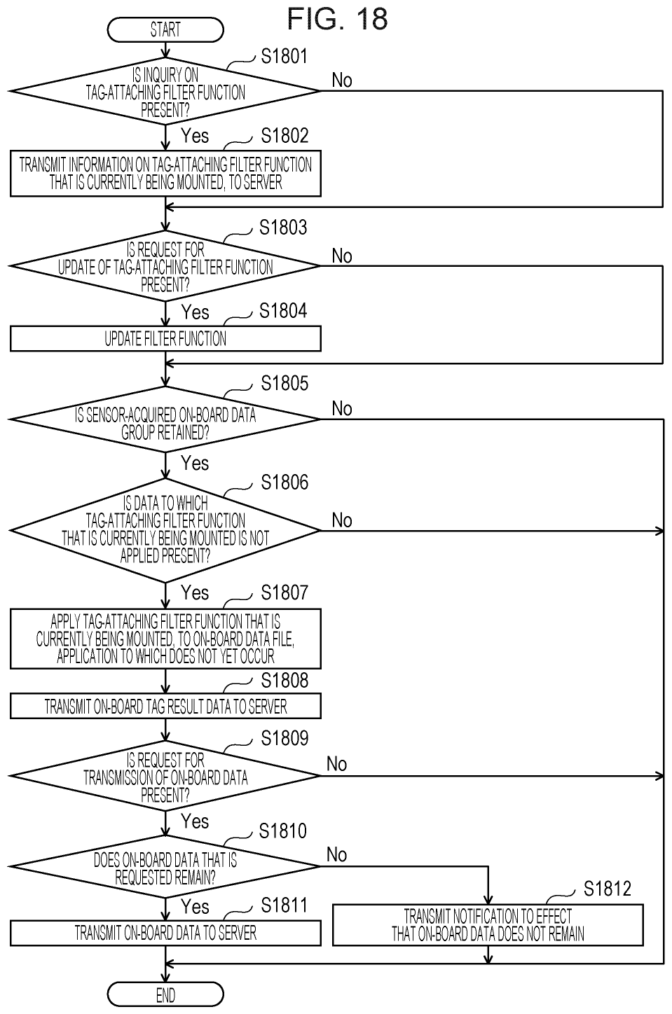

FIG. 18 is a flowchart illustrating an example of a procedure for processing by the on-board apparatus. In the flowchart in FIG. 18 with reference to FIG. 1, the on-board apparatus 102 determines whether or not an inquiry on the tag-attaching filter function from the server 101 is present (Step S1801). In a case where the inquiry is present (Yes in Step S1801), information on the tag-attaching filter function that is currently being mounted is transmitted to the server 101 (Step S1802), and proceeding to Step S1803 takes place. On the other hand, in a case where the inquiry is not present (No in Step S1801), proceeding to Step S1803 takes place without doing anything.

The on-board apparatus 102 determines whether or not a request for update of the tag-attaching filter function from the server 101 is present (Step S1803). In a case where the request for the update is present (Yes in Step S1803), the filter function is updated according to a detail of the update of the tag-attaching filter function that is requested by the server, by performing the deletion and the addition (the update) in this order (Step S1804), and proceeding to Step S1805 takes place. On the other hand, in a case where the request for the update is not present (No in Step S1803), proceeding to Step S1805 takes place without doing anything.

Thereafter, the on-board apparatus 102 determines whether or not the sensor-acquired on-board data group is retained (Step S1805). In a case where the sensor-acquired on-board data group is not retained (No in Step S1805), a sequence of processing operations is ended. On the other hand, in a case where the sensor-acquired on-board data group is retained (Yes in Step S1805), it is determined whether or not data to which the tag-attaching filter function that is currently being mounted is not applied is present (Step S1806). In a case where the data to which the tag-attaching filter function that is currently being mounted is not applied is not present (No in Step S1806), a sequence of processing operations is ended.

On the other hand, in Step S1806, in a case where the data to which the tag-attaching filter function that is currently being mounted is not applied is present (Yes in Step S1806) the tag-attaching filter function that is currently being mounted is applied to the on-board data file, application to which does not yet occur (Step S1807). An on-board tag result that is obtained by the application is transmitted to the server 101 (Step S1808).

The on-board apparatus 102 determines whether or not a request from the server 101 for transmission of the on-board data is present (Step S1809). In a case where the request for the transmission of the on-board data is not present (No in Step S1809), a sequence of processing operations is ended. On the other hand, in a case where the request for the transmission of the on-board data is present (Yes in Step S1809), it is determined whether or not the on-board data that is requested remains (Step S1810).

In Step S1810, in a case where the on-board data that is requested remains (Yes in Step S1810), the on-board data is transmitted to the server 101 (Step S1811), and a sequence of processing operations is ended. On the other hand, in a case where the on-board data that is requested does not remain (No in Step S1810), a notification to the effect that the on-board data that is requested does not remain is transmitted to the server 101 (Step S1812) and a sequence of processing operations is ended.

In this way, the on-board apparatus 102 can perform each processing operation while communicating with the server 101.

As described above, according to the present embodiment, regarding the collecting information that is acquired from the information collecting apparatus (the on-board apparatus 102) that collects the information on the mobile body 103, a correlation between a categorization result that is obtained by categorizing the collecting information into at least two groups, and a result that is obtained by filtering the collecting information based on the accompanying information is determined. Based on the determined correlation, new accompanying information that is to be mounted in the information collecting apparatus is determined from the accompanying information. The determined new accompanying information is distributed to the information collecting apparatus. A computer (the server 101) performs these processing operations. Accordingly, the information collecting apparatus (the on-board apparatus 102) can perform more suitable filtering, which is based on the new accompanying information that is newly distributed, on the collecting information, and can decrease the transmission of desirable information to the computer (the server 101). As a result, communication cost can be lowered.

In the present embodiment, the accompanying information may be information relating to the filter function that depends on a tag indicating a data portion that is consistent with the categorization result. In the present embodiment, the collecting information may include image data or audio data. In the present embodiment, the information collecting apparatus may be the on-board apparatus 102 that is mounted in the mobile body 103, and the collecting information may be on-board information (the on-board data 401) of the mobile body 103.

In the present embodiment, the computer (the server 101) may perform processing that predicts the amount of data communication change pertaining to communication of the collecting information (the on-board data 401) from the information collecting apparatus (the on-board apparatus 102), which entails a change to new accompanying information (information relating to the tag-attaching filter function). Processing that determines the new accompanying information may be set to be performed based on the predicted amount of data communication change. Accordingly, transmission of undesirable information to the computer (the server 101) can be reduced more suitably and reliably.

In the present embodiment, the processing that determines the correlation is performed based on the number of times of consistency with, or the number of times of non-consistency with, any group that results from the categorization, in the categorization result, or any combination thereof. For example, the processing that determines the correlation may be performed based on only the number of times of consistency, may be performed based on only the number of times of non-consistency, and may be performed based on both the number of times of consistency and the number of times of non-consistency. Accordingly, for example, the greater the number of times of consistency, the more suitable determination can be made. The smaller the number of times of non-consistency, the more suitable determination can be made.

In the present embodiment, the processing that determines new accompanying information (the tag-attaching filter function information) may be set to be performed based on the information relating to the information collecting apparatus (the on-board apparatus 102), the mobile body 103, the information on which is collected by the information collecting apparatus, or any combination thereof. That is, the processing that determines the new accompanying information may be performed based on the information relating to the information collecting apparatus, may be performed based on the information relating to the mobile body 103, and may be performed based on both the pieces of information on the information collecting apparatus and the mobile body 103. Accordingly, suitable accompanying information can be provided (distributed) that is based on a detail (performance or the like) of the information processing apparatus, or is based on a detail (a type of vehicle or the like) of the mobile body.

In the present embodiment, the categorization results may be a result that is obtained by categorizing pieces of collecting information that are received from the information collecting apparatus (the on-board apparatus 102), into information that is selected and information that is not selected. Accordingly, in a case where the selected information is set to be useful information, more suitable accompanying information (tag-attaching filter function information) can be distributed (provided) to the information collecting apparatus, and more suitable filtering can be accordingly performed.

In the present embodiment, the categorization may be set to be performed by the operator. For example, in some cases, the determination depending on the manpower is correct such as categorization that uses an image (a picture), and more suitable accompanying information (tag-attaching filter function information) can be accordingly distributed (provided) to the information collecting apparatus (the on-board apparatus 102).

For example, because the tag-attaching filter function that is closer to an on-board data result that results from the operator or the like performing the sorting in advance can be estimated, the tag-attaching filter function and the tag that are used for filtering on the on-board apparatus 102 side can be optimized. As a result, because the collecting of the on-board data 401 can be determined in advance only with the on-board tag result data that is tag-attached in the on-board apparatus 102, it is possible that, without transmitting undesirable on-board data from the on-board apparatus 102 to the server 101, the amount of data communication is reduced to that extent and it is possible that the on-board data is collected at low cost.

In the present embodiment, when new accompanying information (tag-attaching filter function information) is distributed to the information collecting apparatus (the on-board apparatus 102), only a difference between the accompanying information that the information collecting apparatus has and the new accompanying information may be set to be distributed. Accordingly, the communication cost that is incurred when the accompanying information is delivered can be lowered.

According to the present embodiment, the data distribution apparatus can include a control unit. The control unit determines the correlation between the categorization result that is obtained by categorizing the collecting information into at least two groups and the result that is obtained by filtering the collecting information based on the accompanying information, regarding collecting information that is acquired from the information collecting apparatus 102 that collects the information on the mobile body 103, determines new accompanying information that is to be mounted in the information collecting apparatus, from the accompanying information, based on the determined correlation, and distributes the determined new accompanying information to the information collecting apparatus. The control unit, for example, can be configured with the tag filter checking and updating unit 111, the on-board data tag-attaching unit 112, the tag filter effectiveness evaluating unit 113, the tag-filter on-board apparatus mounting unit 114, the on-board tag interpretation result receiving unit 115, and the on-board data request acquiring unit 116, which are included in the server 101.

According to the present embodiment, the data distribution system can collect the information on the mobile body 103, can determine the correlation between the categorization result that is obtained by categorizing the collected collecting information into at least two groups and the result that is obtained by filtering the collecting information based on the accompanying information, can determine new accompanying information that is applied to the filtering of the collecting information, from the accompanying information, based on the determined correlation, and can distribute the determined new accompanying information. The data distribution system can be configured with the server 101, the on-board apparatus 102, and the like.

In this manner, according to the present embodiment, the on-board tag result data that is created with the tag-attaching filter function of the on-board apparatus 102, which, as a reference, is referred to when a cloud computing system (the center side) collects the on-board data (the data group having a large volume of data, such as an picture, audio, or detailed vehicle information CAN) can approach data that is closest to a filtering result which is determined by the operator or the like in the center. Because of this, it is possible that the cost of collecting undesirable on-board data is suppressed and that the on-board data that has a higher utility value is collected.

For example, it is possible that the tag-attaching filter function relating to the learning performance, which is such that, as an amount of collected on-board data 401 increases, a detail of the filtering changes to a higher degree, is mounted at an arbitrary timing in the on-board apparatus 102. With a type of vehicle in which the on-board apparatus 102 is mounted, a traveling history of the vehicle in which the on-board apparatus 102 is mounted, or the like, the tag-attaching filter function that is mounted at any time in the on-board apparatus can be caused to change. Because of this, it is also possible that the plan for collecting the on-board data becomes a reality. These can find application in traveling scene situation check (collecting of a representative scene associated with an accident or autonomous driving, road side analysis, and the like), creation and update of a road map, and the like.

A so-called request-type on-board data collecting system can be efficiently realized at low cost. In the request-type on-board data collecting system, the information that is collected in the server 101 from the on-board apparatus 102 is checked, on-board apparatuses 102 that are targets for collecting detailed on-board data and pieces of on-board data 401 are then narrowed down, and thus desirable on-board data 401 is collected by request from the on-board apparatus 102.

The data distribution method that is described in the present embodiment can be realized by causing a computer, such as a personal computer or a workstation, to execute a program that is prepared in advance. The data distribution program is recorded on a computer-readable recording medium, such as a hard disk, a flexible disk, a compact disc (CD)-ROM, a magneto-optical (MO) disk, a digital versatile disk (DVD), or a Universal Serial Bus (USB) memory, and is executed by being read a computer from the recording medium. The data distribution program may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data distribution method performed by a computer, the data distribution method comprising:
determining a correlation between a categorization result that is obtained by categorizing collecting information into at least two groups and a result that is obtained by filtering the collecting information by accompanying information, the collecting information being collected from an information collecting apparatus that collects information concerning a mobile body;
determining new accompanying information that is to be stored in the information collecting apparatus, from the accompanying information, based on the determined correlation; and
distributing the determined new accompanying information to the information collecting apparatus.

2. The data distribution method of claim 1, the process further comprising
predicting an amount of data communication change pertaining to communication of the collecting information from the information collecting apparatus, which entails a change to the new accompanying information, wherein
the determining of the new accompanying information is performed based on the predicted amount of data communication change.

3. The data distribution method of claim 1, wherein
the determining of the correlation is performed based on a number of times of consistency with, or a number of times of non-consistency with, each piece of collecting information in any group that results from the categorization, in the categorization result, or any combination thereof.

4. The data distribution method of claim 1, wherein
the determining of the new accompanying information is performed based on information relating to the information collecting apparatus, a mobile body, information collected by the information collecting apparatus, or any combination thereof.

5. The data distribution method of claim 1, wherein
the categorization result is a result that is obtained by categorizing pieces of collecting information that are received from the information collecting apparatus, into information that is selected and information that is not selected.

6. The data distribution method of claim 1, wherein
the accompanying information is information relating to a filter function that depends on a tag indicating a data portion that is consistent with the categorization result.

7. The data distribution method of claim 1, wherein the categorizing is performed by an operator.

8. The data distribution method of claim 1, wherein the collecting information includes image data.

9. The data distribution method of claim 1, wherein,
when the new accompanying information is distributed to the information collecting apparatus, only a difference between the accompanying information that the information collecting apparatus has and the new accompanying information is distributed.

10. The data distribution method of claim 1, wherein:
the information collecting apparatus is an on-board apparatus that is mounted in the mobile body; and,
the collecting information is the information concerned with the mobile body and collected by on-board sensors.

11. A data distribution apparatus comprising:
a memory; and
a processor coupled to the memory and configured to:
determine a correlation between a categorization result that is obtained by categorizing collecting information into at least two groups and a result that is obtained by filtering the collecting information by accompanying information, the collecting information being collected from an information collecting apparatus that collects information concerning a mobile body,
determine new accompanying information that is to be mounted in the information collecting apparatus, from the accompanying information, based on the determined correlation, and
distribute the determined new accompanying information to the information collecting apparatus.

12. A data distribution method comprising:
determining whether a sorting-completed on-board data group is present;
performing a filter function, which is a mounting consideration target and not mounted in a vehicle yet, on the sorting-completed on-board data group and attaching tag-categories concerned with results of performing the filter function to the sorting-completed on-board data group, when a determination is made that the sorting-completed on-board data groups is present;
calculating a correlation between the sorting-completed on-board data groups and the tag-categories attached to the sorting-completed on-board data group;
calculating an amount of data communication change on condition that the tag-attaching filter function is newly mounted in a vehicle;
determining whether the filter function is to be mounted in a vehicle, by the correlation and the amount of data communication change.
